(19) United States
(12) Patent Application Publication
(10) Pub. No.: US 2026/0267405 A1
(43) Pub. Date: Sep. 10, 2026

(54) PORTABLE INFORMATION TERMINAL AND METHOD FOR DISPLAYING VIRTUAL REALITY OBJECT

(71) Applicant: Maxell, Ltd., Kyoto (JP)

(72) Inventors: Mayumi NAKADE, Kyoto (JP); Yasunobu HASHIMOTO, Kyoto (JP); Hitoshi AKIYAMA, Kyoto (JP); Kazuyuki TAKIZAWA, Kyoto (JP); Tatsuro NAKAMURA, Kyoto (JP)

(21) Appl. No.: 19/164,878

(22) PCT Filed: Mar. 17, 2023
(86) PCT No.: PCT/JP2023/010644

§ 371 Date: Sep. 12, 2025

(51) Int. Cl. G06F 3/01; G06T 7/73; G06T 19/00; G06V 10/772; G06V 10/774; G06V 20/20; G06V 30/19; G06V 30/416; G06V 40/16; G06V 40/18

(52) U.S. Cl. CPC G06F 3/013; G06T 7/74; G06T 19/006; G06V 20/20; G06V 30/416; G06V 10/772; G06V 10/774; G06V 30/1914; G06V 40/174; G06V 40/18; G06V 2201/131

(57) ABSTRACT

A portable information terminal is configured to: carry out an image analysis on a captured image captured by a camera; based on description information included in a document captured in the captured image, extract appearing object information including attribution information about an appearing object which appears in the document; store the appearing object information in a memory; acquire line-of-sight information obtained and output by a line-of-sight detection sensor that has detected a line of sight of a user; identify a portion on which a viewpoint of the user is present; generate a virtual reality object including a description about the appearing object corresponding to the portion on which the viewpoint of the user is present based on the appearing object information; and display the virtual reality object in a display area of a display, which corresponds to a periphery of the document.

### TECHNICAL FIELD

The present invention relates to a portable information terminal and a method for displaying a virtual reality object.

### BACKGROUND ART

As an example of reading support technology, Patent Literature 1 discloses a “digital book device comprising: a reading history information acquisition unit that acquires reading history information corresponding to reading behavior instructions such as open commands and page-turning commands for digital books; a read section information acquisition unit that acquires one or more read section information items, which are information items for identifying the sections that have been already read, based on the one or more reading history information items; an appearing object acquisition unit that acquires one or more appearing objects, which are one type of objects appearing in the read sections, based on the one or more read section information items; and an un-appearing object acquisition unit that acquires one or more un-appearing objects, which are one type of objects appearing in unread sections, based on the one or more read section information items, and an object display unit that displays one or more the appearing objects and one or more the un-appearing objects in different display modes, respectively, for the purpose of identifying the objects that will appear afterwards” (excerpt from Abstract).

### CITATION LIST

### Patent Literature

Patent Literature 1: JP-A-2012-194771

### SUMMARY OF INVENTION

### Technical Problem

The digital book device according to Patent Literature 1 can support reading of electronic books in which the document contents are digitized in advance. However, in the case of reading and viewing the partial document data that is displayed each time, for example, in the case of reading printed books, newspapers, and technical documents, and serial novels available on smartphones, the digital book device according to Patent Literature 1 cannot acquire the electronic data of the whole document in advance, which causes a problem that the reading support has to be limited to the electronic books only.

The present invention has been made in order to solve the problem described above, and an object thereof is to provide a portable information terminal and a method for displaying a virtual reality object, which are capable of carrying out reading or viewing support for, not only digital books, but also various forms of books and videos that a user wants to read and view.

### Solution to Problem

In order to achieve the object described above, the present invention includes the features described in the scope of claims. An aspect of the present invention is a portable information terminal, comprising: a camera that captures an image of a field of view of a user and generates a captured image; a display; a memory; a line-of-sight detection sensor that detects a line of sight of the user and outputs line-of-sight information; and a processor, the processor being configured to: carry out an image analysis on the captured image to extract appearing object information including attribution information about an appearing object which appears in a document included in the captured image; store the appearing object information in the memory; acquire the line-of-sight information to identify a portion on which a viewpoint of the user is present; generate a virtual reality object including a description about the appearing object corresponding to the portion which the viewpoint of the user is present based on the appearing object information; and display the virtual reality object in a display area of the display, which corresponds to a periphery of the document.

### Advantageous Effects of Invention

According to the present invention, it is possible to provide a portable information terminal and a method for displaying a virtual reality object, which are capable of carrying out reading or viewing support for, not only digital books, but also various forms of books and videos that a user wants to read and view. The problems, configurations, and advantageous effects other than those described above will be clarified by explanation of the embodiments below.

### BRIEF DESCRIPTION OF DRAWINGS

FIG. 1 is a hardware configuration diagram of a portable information terminal according to the first embodiment.

FIG. 2 is a hardware configuration diagram of an HMD according to the present embodiments.

FIG. 3 is a functional block diagram illustrating a portable information terminal according to the present embodiments.

FIG. 4 is a schematic diagram illustrating an example of usage state of a portable information terminal according to the present embodiments.

FIG. 5 is a flowchart showing an overview of an example of reading support processing by a portable information terminal according to the first embodiment.

FIG. 6 is a flowchart showing the details of appearing object information extraction processing.

FIG. 7 is a diagram illustrating an example of an appearing object information database.

FIG. 8 is a diagram illustrating an example in adding information in an appearing object information database.

FIG. 9 is a diagram illustrating an example of an environment information database.

FIG. 10 is a flowchart showing the details of reading support information generation processing.

FIG. 11 is a schematic diagram illustrating an example of age edition processing carried out on a reference model of a human.

FIG. 12 is a diagram illustrating an example of age edition using a physical constitution chart.

FIG. 13 is a diagram illustrating an example of age edition using a body proportions chart.

FIG. 14 is a flowchart showing a detailed processing example of character image display processing.

FIG. 15 is a schematic diagram illustrating a display example (constant display example) of a character image.

FIG. 16 is a schematic diagram illustrating a display example (detailed display example) of a character image.

FIG. 17 is a flowchart showing a flow of processing according to the second embodiment.

FIG. 18 is a diagram illustrating an example of unsureness detection processing.

FIG. 19 is a diagram illustrating a further example of unsureness detection processing.

FIG. 20 is a flowchart showing a flow of processing according to the third embodiment.

FIG. 21 is a schematic diagram illustrating an example of autonomous generation of a correlation chart of appearing objects according to the third embodiment.

FIG. 22 is a schematic diagram illustrating a display example of a correlation chart according to the third embodiment.

FIG. 23 is a flowchart showing a flow of processing according to the fourth embodiment.

FIG. 24 is a diagram illustrating a display example of a plot summary.

FIG. 25 is a schematic diagram illustrating an example of obtaining a character model from an external apparatus.

FIG. 26 is a schematic diagram illustrating an example of cutting a character model out from an illustration.

FIG. 27A is a schematic diagram illustrating an example of cutting a character model out from a video.

FIG. 27B is a schematic diagram illustrating an example of cutting a character model out from a video.

FIG. 28 is a schematic diagram illustrating an example of displaying an illustration or a diagram for reference using an AR display technique.

FIG. 29 is a diagram illustrating a virtual reality display system according to the eighth embodiment.

FIG. 30 is a flowchart showing a flow of processing (processing example 1) according to the eighth embodiment.

FIG. 31 is a flowchart showing a flow of processing (processing example 2) according to the eighth embodiment.

### DESCRIPTION OF EMBODIMENTS

Hereinafter, embodiments of the present invention will be described with reference to the drawings. The same elements and steps are provided with the same reference signs throughout the drawings, and in some cases, repetitive descriptions thereof will be omitted.

According to the present embodiment, it is possible to provide a portable information terminal and a method for displaying a virtual reality object which supports a user who is reading a book or watching a video so as to allow him or her to understand characters or scenes well. This enables support when reading, for example, long novels, stories involving many characters, or document materials which require the user to read while referring to attached data such as drawings and graphs. Therefore, the present invention can be expected to contribute to 8.2 (Achieve higher levels of economic productivity through diversification, technological upgrading and innovation, including through a focus on high-value added and labor-intensive sectors” of the Sustainable Development Goals (SDGs) proposed by the Sectioned Nations.

### First Embodiment

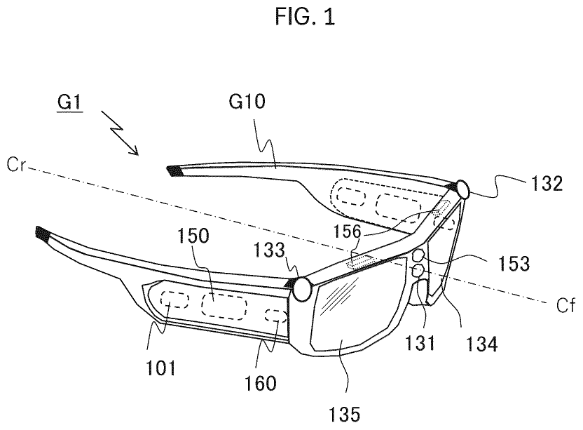

FIG. 1 is a hardware configuration diagram of a portable information terminal according to the first embodiment. In the present embodiment, an example of a configuration in which a user support program is installed in a head-mounted display (hereinafter, referred to as an “HMD”) as an example of a portable information terminal will be described. However, the portable information terminal may be smart glasses.

In FIG. 1, an HMD G1 includes an eyeglass-shaped housing G10, and the housing G10 is provided with a left display 134 and a right display 135 which include display surfaces, respectively. Each of the left display 134 and the right display 135 is, for example, a see-through display with a display surface through which a real image of the outside field around the HMD G1 is displayed and a virtual reality object (hereinafter, referred to as an “AR object”) is superimposed and displayed on the real image. On the housing G10, a main processor 101, a front camera 131, a left camera 132, a right camera 133, a communication I/F 160 (corresponding to a communication apparatus), a ranging sensor 153, a sensor group 150 including various other sensors, and the like are mounted. A reference sign Cf-Cr represents the centerline of the HMD G1.

In the present embodiment, the HMD G1 is equipped with a see-through display, however, it may be an immersive HMD. The immersive HMD may employ a video see-through display for displaying a video obtained by combining the surroundings captured by the front camera 131 and AR object images or text.

The earphones may be provided on portions of the housing G10, which are close to the ears of a user U1 when he or she wears the HMD G1. The battery may also be provided on the housing G10.

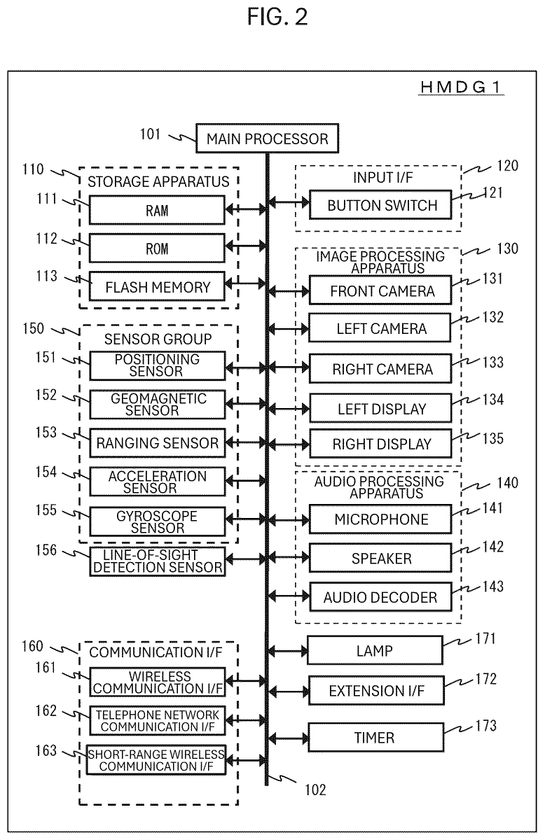

Furthermore, a line-of-sight detection sensor 156 (see FIG. 2) for detecting the line of sight of the user U1 is provided on the inner surface of the housing G10, in other words, the surface facing the user U1 when he or she wears the HMD G1. The line-of-sight detection sensor 156 may be configured to detect not only the line-of-sight direction of the user U1 but also the opening and closing of his or her eyes.

In a further example of the hardware configuration of the portable information terminal, the display and the controller may be separately provided and communicated with each other by wired or wireless communication. In such a configuration, for example, the left display 134, the right display 135, and the sensor group 150 are mounted on the housing G10 of the HMD G1 or the smart glasses. An information apparatus such as a smartphone, a tablet, or a personal computer may be communicated with the HMD G1 so that the user support processing can be executed using a processor mounted on the information apparatus.

FIG. 2 is a hardware configuration diagram of the HMD according to the present embodiment.

In FIG. 2, the HMD G1 includes a main processor 101, a system bus 102, a storage apparatus 110, an input I/F 120, an image processing apparatus 130, an audio processing apparatus 140, the sensor group 150, the communication I/F 160, a lamp 171, an extension I/F 172, and a timer 173. The lamp 171 may be used as a reading light. In the case where the left display 134 and right display 135 are the see-through displays, variable lens capable of changing the visual acuity correction level may be laminated on each of the left display 134 and the right display 135. This allows a person with presbyopia to read easily if he or she wears the HMD G1 or smart glasses. This also allows a person with myopia to watch a video such as a movie easily if he or she wears the HMD G1 or smart glasses.

The main processor 101 is a microprocessor unit for controlling the whole operations of the HMD G1 in accordance with a predetermined operation program. The main processor 101 mainly carries out the system control for carrying out the user support processing based on the input made by the user U1 of the HMD G1 or a captured image captured by the front camera 131, and also carries out the generation of an AR object image to be displayed and the display control therefor.

The system bus 102 is a data communication path for transmitting and receiving various commands, data, and the like between the main processor 101 and the configuration blocks in the HMD G1.

The storage apparatus 110 includes a program for controlling the operations of the HMD G1, an operation setting value, sensor information output from various sensors included in the sensor group 150, and a rewritable work area such as a work area to be used in various program operations.

In the present embodiment, a RAM (Random Access Memory) 111, a ROM (Read Only Memory) 112, and a flash memory 113 are exemplified as the elements configuring the storage apparatus 110, however, a medium capable of holding stored information even while power is not supplied to the HMD G1 from the outside, for example, a semiconductor-device memory such as an SSD (Solid State Drive) or a magnetic disk drive such as an HDD (Hard Disc Drive) may be used. The RAM 111 functions as a work area in which a program is loaded and executed by the main processor 101.

The input I/F 120 is an input interface for inputting an operation instruction for the HMD G1. The input I/F is configured with an operation key including button switches 121 and the like. The input I/F 120 may further include other operation devices. Alternatively, using the communication I/F 160, the HMD G1 may be operated by means of an information device connected thereto by wired communication or wireless communication.

The image processing apparatus 130 includes the front camera 131, the left camera 132, the right camera 133, the left display 134, and the right display 135. Each of the front camera 131, the left camera 132, and the right camera 133 is a camera unit that converts visible light input from the lens into an electric signal using electronic apparatus such as a CCD (Charge Coupled Device) and CMOS (Complementary Metal Oxide Semiconductor) sensor to input visible image data about the surroundings or objects.

Each of the left camera 132 and the right camera 133 includes a wide-angle lens using, for example, a fisheye lens, which allows an image of a scene outside the field of view of the left display 134 and the right display 135 of the HMD G1 to be captured as well.

In each of the left display 134 and the right display 135, the display surface thereof is irradicated with projection light obtained from a display device such as a liquid crystal panel so as to display an image. Each of the left display 134 and the right display 135 includes a video RAM (not illustrated). The image is displayed on the display screen based on the image data input to the video RAM.

The front camera 131 may further include a TOF (Time Of Flight) sensor capable of acquiring a distance to the object being captured as a distance image. This enables accurate detection of the selection by means of an operation of, for example, holding a hand over a plurality of displayed images being displayed on the HMD and pinching an image with a thumb and an index finger (hereinafter, referred to as pointing), using the visible image and the distance image.

Furthermore, using the visible image and the distance image enables measurement of a distance to the object at which the user U1 is gazing. In this case, the ranging sensor 153 may not be provided.

Still further, by scanning the surroundings, a three-dimensional space map may be generated using the output from the sensor group 150 and the image processing apparatus 130 described above.

The audio processing apparatus 140 includes a microphone 141, a speaker 142, and an audio decoder 143. The microphone 141 converts the voice of the user U1 or the like into audio data, and inputs the audio data. The speaker 142 is a stereo speaker, and outputs the audio information and the like necessary for the user U1. The audio decoder 143 has a function of carrying out the decoding processing (audio synthesizing processing) and the like on the encoded audio signal and a three-dimensional audio processing function for each audio transmission property, as needed, to output a three-dimensional sound to the user U1 of the HMD G1 through the speaker 142.

The sensor group 150 includes various sensors for detecting the condition of the HMD G1. The sensor group 150 includes a positioning sensor 151 for measuring a position using a satellite position such as a GPS (Global Positioning System), a geomagnetic sensor 152, a ranging sensor 153, an acceleration sensor 154, and a gyroscope sensor 155. Providing these sensors allows the position, tilting, orientation, motion, and the like of the HMD G1 and a distance to an object being watched to be detected. In addition, the HMD G1 may further include other sensors such as an illuminance sensor and a proximity sensor. The positioning sensor 151 is a sensor for a satellite positioning system to be used, for example, a global navigation satellite system (GNSS), a satellite constellation for reinforcing and correcting the collected data in order to improve the accuracy in positioning, a regional public information satellite system, or the like.

The line-of-sight detection sensor 156 detects the line of sight of the user U1 wearing the HMD G1. A method for detecting the line of sight by irradiating the eyes of the user U1 with non-visible light (for example, infrared light) to obtain an image of the pupils from the captured image by the image processing has been known, however, it is not limited to a particular one.

The communication I/F 160 includes a wireless communication I/F 161, a telephone network communication I/F 162, and a short-range wireless communication I/F 163.

The wireless communication I/F 161 is connected to a network such as the Internet via an access point, a wireless router, or the like, and transmits and receives data to and from a server on the network. It may be connected to the access point, the wireless router, or the like by wireless connection such as Wi-Fi (registered trademark).

A telephone network communication I/F 162 carries out the telephone communication (call) and data transmission and reception by wireless communication with a base station of a mobile wireless communication network. The communication with a base station B1 or the like may be carried out by other communication systems, for example, a W-CDMA (Wideband Code Division Multiple Access (registered trademark) system, a GSM (registered trademark) (Global System for Mobile communications) system, an LTE (Long Term Evolution) system, 5G system, and the like.

Each of the wireless communication I/F 161 and the telephone network communication I/F 162 includes an encoding circuit, a decoding circuit, an antenna, and the like.

The short-range wireless communication I/F 163 has a communication function of a BlueTooth (registered trademark) system as an example, however, is not particularly limited thereto, and may employ other communication systems such as infrared communication.

The HMD G1 further includes the lamp 171 for illuminating the field of view of the user U1, the extension I/F 172 (for example, a USB terminal) for connecting to an external apparatus to extend the functions, and the timer 173.

Although the configuration example of the HMD G1 illustrated in FIG. 2 includes the elements which are not essential to the present embodiment, the advantageous effects of the present embodiment are not impaired even in a configuration in which these components are not provided. Furthermore, the elements such as a digital broadcast reception function and an electronic money settlement function (not illustrated) may be further added thereto.

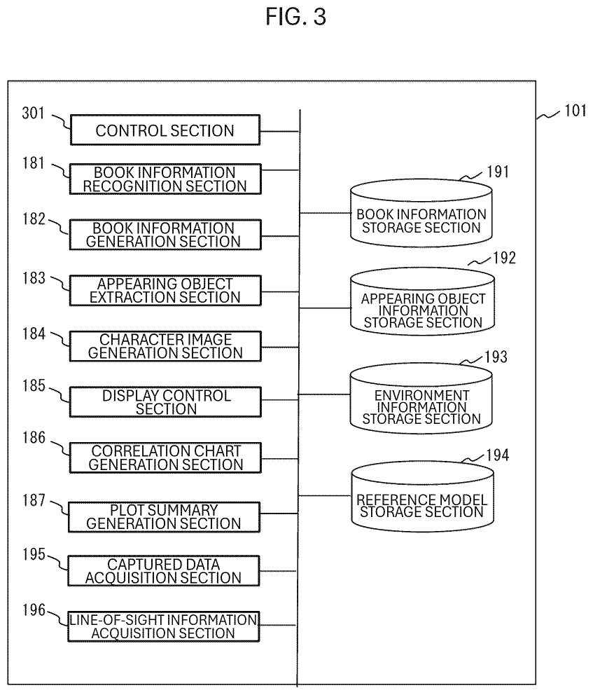

FIG. 3 illustrates a functional block diagram of a portable information terminal according to the present embodiment.

The HMD G1 includes a book information recognition section 181, a book information generation section 182, an appearing object extraction section 183, a character image generation section 184, a display control section 185, a correlation chart generation section 186, a plot summary generation section 187, a book information storage section 191, an appearing object information storage section 192, an environment information storage section 193, a reference model storage section 194, a captured data acquisition section 195, a line-of-sight information acquisition section 196, and a control section 301.

The main processor 101 loads and executes the user support program on the RAM 111 so that the functions of the book information recognition section 181, the book information generation section 182, the appearing object extraction section 183, the character image generation section 184, the display control section 185, the correlation chart generation section 186, and the plot summary generation section 187 are implemented.

The book information storage section 191, the appearing object information storage section 192, the environment information storage section 193, and the reference model storage section 194 are formed in a partial area of the flash memory 113.

The captured data acquisition section 195 acquires a video captured by the front camera 131, and as necessary, those captured by the left camera 132 and the right camera 133.

The line-of-sight information acquisition section 196 acquires the line-of-sight information about the user U1 from the line-of-sight detection sensor 156.

The detailed functions of the other elements will be described later with reference to the flowcharts. All the functions described above do not have to be necessarily provided, but only the functions necessary in each embodiment may be provided.

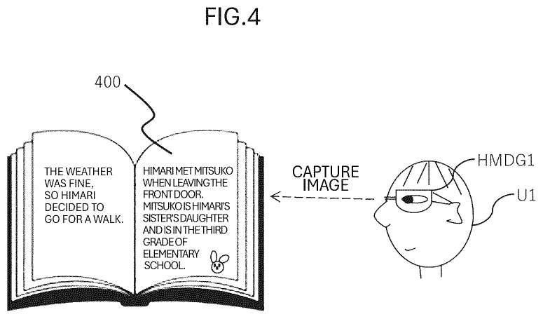

FIG. 4 is a schematic diagram illustrating an example of usage state of a portable information terminal according to the present embodiment.

FIG. 4 illustrates the user U1 who is wearing the HMD G1 and reading a book 400. The HMD G1 is equipped with a see-through display, which allows the user U1 to actually see the book 400 through the left display 134 and the right display 135. The book 400 includes the documents, illustrations, and the like. While watching the sentences, illustrations, and the like, the user U1 can capture the images of them using the front camera 131 of the HMD G1.

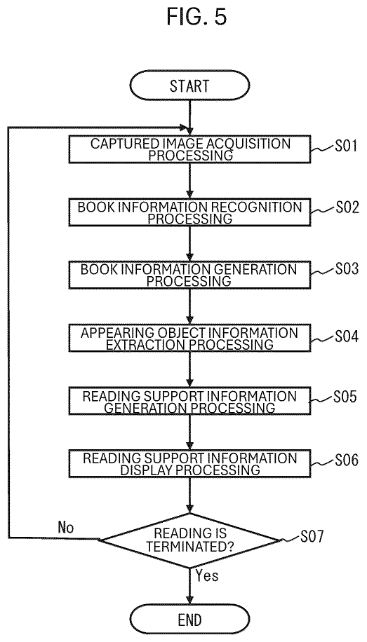

FIG. 5 illustrates a flowchart showing an overview of an example of reading support processing by the portable information terminal according to the first embodiment.

In response to the determination by the control section 301 that the user U1 wearing the HMD G1 starts reading, the captured image acquisition section 195 acquires a captured image including the book being read by the user U1, which has been captured by the front camera 131 (S01).

The control section 301 determines that reading has been started, for example, based on the actions performed by the user U1 such as selection of the function thereof, attachment of the HMD G1, turning-on of the HMD G1, and the like, or when it is determined that the book is included in the captured image acquired by the captured data acquisition section 195 or that the user U1 is looking at the book for a certain period of time or longer based on the line-of-sight information acquired from the line-of-sight information acquisition section 196 and the captured image acquired by the captured data acquisition section 195, or the like.

The control section 301 causes the book information recognition section 181 to execute the book information recognition processing of extracting the book and the text written in the book from the captured image (S02). The extraction of a book and the extraction of an illustration and the like included in the book are carried out using, for example, an AI (Artificial Intelligence) for image recognition and the like, to recognize the text and the like written in the extracted book. The recognition of text may be carried out by, for example, a module that executes an OCR (Optical Character Recognition/Reader) function, or may be carried out using an AI for text recognition that has carried out machine-learning using the information about the shapes of letters as teacher data. The extraction of a book may be carried out by determining the book based on the shape of the book measured using the ranging sensor 153, or by extracting the book from among those within a distance range in which reading is assumed to be performed.

The control section 301 causes the book information generation section 182 to make a sentence using the text obtained by the text recognition and the like to generate document information, make the document information associated with position information (page, number of lines, line number, and the like) and reading time information to generate book information, and record the book information in the book information storage section 191 (S03). Here, if the book information storage section 191 retains the book information already recorded therein, the book information is compared with the already recorded book information to find whether the book information includes newly generated sentence information or the like, and if any, the newly generated sentence information or the like is recorded in the book information storage section 191. The management and comparison of the book information may be carried out not on the whole book information but on a page-by-page basis. There may be cases where information for one page of the book cannot be acquired at once depending on an image capturing area, presence of an obstacle, or the reason such that the user U1 is folding a book while reading. In these cases, however, using a plurality of captured images and adding newly recognized sentence information or the like allows the book information without missing information to be generated. Furthermore, if it is determined that the book information about the page which is being seen by the user U1 has been already acquired, the book information generation section 182 may omit the additional determination processing for the book information.

The control section 301 causes the appearing object extraction section 183 to analyze the book information recorded in the book information storage section 191 to extract description information about an appearing object of, for example, a character. The description information is recorded in the appearing object information storage section 192 for each appearing object as attribution information (S04). The appearing object is not limited to that of an appearing person, and may be that of an appearing animal or plant such as a dog, a cat, a bird, fish, or a tree, or that of a stationary object such as a building or furniture. The description information about the appearing object to be extracted may include not only the information for describing the appearing object such as the name, the age, the appearance, and the like, but also the information for identifying a scene where the object appeared, for example, the date and time, the scene, and the place.

The control section 301 causes the character image generation section 184 to generate a character image for each appearing object based on the attribution information about the appearing object stored in the appearing object information storage section 192. The form of the character image to be generated may be varied depending on the position of the book that the user U1 is reading. The position of the book that the user U1 is reading is identified, for example, by identifying the position on the book where the viewpoint of the user U1 is positioned based on the page of the book which is being opened and the line-of-sight information about the user U1 as acquired. The character image generation section 184 generates the character image serving as the reading support information using the attribution information about the appearing object, which was generated so as to correspond to the pages from the beginning of the book to the position of the book that the user U1 is reading (S05). In the reading support information generation processing, a new character image does not have to be necessarily always generated. The generated character image may be recorded in advance so as to allow the generation processing to be carried out only when there is a change in the attribution information about the appearing object. The character image to be displayed may be generated at the timing of being displayed by the display control section 185.

The control section 301 causes the display control section 185 to decide a display area of the character image using the position information about the book extracted by the image analysis processing or the like based on the captured image acquired by the captured data acquisition section 195, and to display the character image as an AR object on the left display 134 and the right display 135 (S06).

The display control section 185 may display the character image together with the detailed information about the character image. In this case, the display control section 185 reads the attribution information about the character image to be displayed from a database (see FIG. 7) of the appearing object information storage section 192, and displays it near the character image. The attribution information to be displayed may be the predetermined one, or the user U1 may add or delete the attribution information to be displayed. Furthermore, for example, the detailed information may be configured to be popped-up in response to the selection of the character image.

Upon determining that the character image that has been displayed is to be hidden, the control section 301 causes the display control section 185 to cancel the display of the AR object. Whether to cancel the display of the AR object may be determined based on, for example, whether the time in which the AR display is displayed is equal to or more than a predetermined time threshold, whether the scene has been switched, whether the manipulation by the user has been found, and the like.

If the control section 301 determines that the reading is continued (S07: No), the processing returns to step S01 and then repeated. If determining that the reading has been terminated (S07: Yes), the control section 301 stores the latest information about the appearing object and the information indicative of the last position that the user U1 read in the flash memory 113, and then the user support processing is ended.

As a condition for determining whether reading has been terminated, any one of or a combination of the followings, for example,
(1) whether the HMD G1 was powered off or whether the HMD G1 has detected that the application was terminated,
(2) whether the HMD G1 has detected that the HMD G1 was taken off from the head of the user U1,
(3) whether the time, in which the book information recognition processing of step S02 could not be performed due to the actions performed by the user U1 such as closing the book, facing a direction different from that of the book, or the like, has been equal to or more than a predetermined reading termination determination time, for example, 1 minute or more,
(4) whether the time in which the user U1 kept closing the eyes has been equal to or more than the predetermined reading termination determination time,
may be applied. The conditions (1) to (3) are the ones suitable for ending the user support processing in response to the intentional reading termination action performed by the user U1. The condition (4) is suitable for ending the user support processing in response to the action such that the user U1 has fallen asleep while reading.

### (S04: Appearing Object Information Extraction Processing)

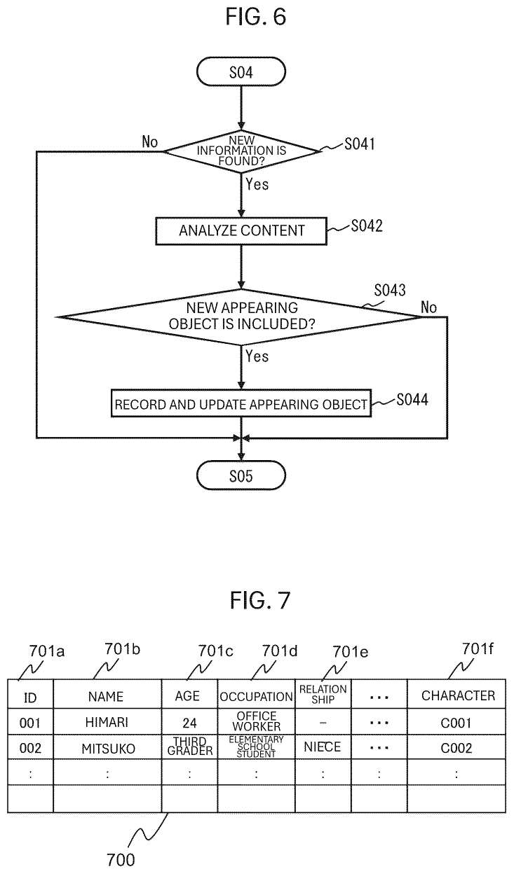

FIG. 6 illustrates a flowchart showing the details of the appearing object information extraction processing.

The appearing object extraction section 183 determines whether new information is included in the book information stored in the book information storage section 191 (S041).

The appearing object extraction section 183 obtains a difference between the book information that was recorded in the book information storage section 191 by the book information generation section 182 in the latest processing, in other words, in one cycle of the immediately preceding processing from step S01 to S09, and the book information that was recorded in the book information storage section 191 by the book information generation section 182 in the current cycle. If new information is found in the difference, the appearing object extraction section 183 determines that step S041 is affirmative.

The case where the new information is found corresponds to the case where the front camera 131 has captured an image of a new portion of the book, specifically, which includes the cases where, for example, a page is updated, an image of a portion that has not been captured is captured, the user U1 goes on reading the book and thus his or her face is turned in a direction different from that therebefore, and the like.

On the other hand, even when a new portion of the book is detected, if the portion is a margin, there is no difference between the book information items and thus no new information is found. In addition, new information may not be included even if there is a difference between the book information items, in such a case that the difference includes only the simulated sound but no development of the story, or that it includes only an annotation of a term but no development in the main part of the story.

Upon finding the description information in the new book information stored in the book information storage section 191 (S041: Yes), the appearing object extraction section 183 carries out content analysis processing (S042). In the content analysis processing, the appearing object extraction section 183 analyzes to which appearing objects of appearing persons, objects, and the like the description information relates, into which attributions the description information is to be classified, and the like. In the case of determining that the appearing object is the new one that has not appeared in the book information so far, the appearing object extraction section 183 stores the attribution information as the one about a new appearing object.

Upon determining that a new appearing object or new appearing object attribution information has been found as a result of the content analysis (S043: Yes), the appearing object extraction section 183 additionally records the new appearing object or the new appearing object attribution information in the appearing object information database of the appearing object information storage section 192, and updates the appearing object information database (S044). In updating, the appearing object extraction section 183 leaves the update history of the appearing object information database on the record. The update history is useful for showing the change in the character of the appearing object over time and the change in an interpersonal correlation chart, and also, it is useful for displaying an appropriate character or the like in the scene of the position of the book at which the user U1 is looking in accordance with the line-of-sight information.

In the cases where: the appearing object extraction section 183 has not found the new information in the book information (S041: No), no new appearing object information is included (S043: No), or the appearing object information database has been updated (S044), the appearing object extraction processing is ended and then the character image generation processing is executed (S05).

FIG. 7 illustrates an example of the appearing object information database.

In an appearing object information database 700 illustrated in FIG. 7, for example, the attribution information such as an “ID” field 701a uniquely indicative of appearing objects, a “name” field 701b indicative of the names of the appearing objects in the text, an “age” field 701c, and an “occupation” field 701d, and the identification information such as a “relationship” field 701e indicative of the relationship with other appearing objects, a “character” image field 701f representing the appearing objects, and the like are recorded in association with each other.

The appearing object extraction section 183 adds data to the appearing object information database as the user U1 goes on reading the text.

FIG. 8 illustrates an example of adding information in the appearing object information database.

An appearing object information database 701 illustrated in FIG. 8 includes “Rin”, “Taro”, and “Ren”, which have been added, as new appearing objects, to the appearing object information database 700 illustrated in FIG. 7.

Furthermore, in the updated appearing object database 701, a “condition” field 701g, in which the change in each character is recorded, is added. For example, the appearing object information database 701 illustrated FIG. 8 includes “foot injury”, which has been added to the condition of “Mitsuko”, as compared with the appearing object information database 700 of FIG. 7.

For example, in the case where the story says at line 10 on page 10 that “Himari” cut her long hair to be short, “long hair to short hair” may be recorded as the information to be recorded in the “condition” field, and “P10L10” may be recorded as the position information about the change. In the case where the user U1 reads back the document, a character image “Himari” wearing long hair may be generated for the pages up to line 10 on page 10 while a character image of “Himari” wearing short hair may be generated for the pages after line 10 on page 10. On the other hand, in the case where it is found for the first time at line 10 on page 10 that “Himari” wears short hair, the character image of “Himari” to be displayed when the user U1 reads back prior to line 10 on page 10 is the one wearing short hair.

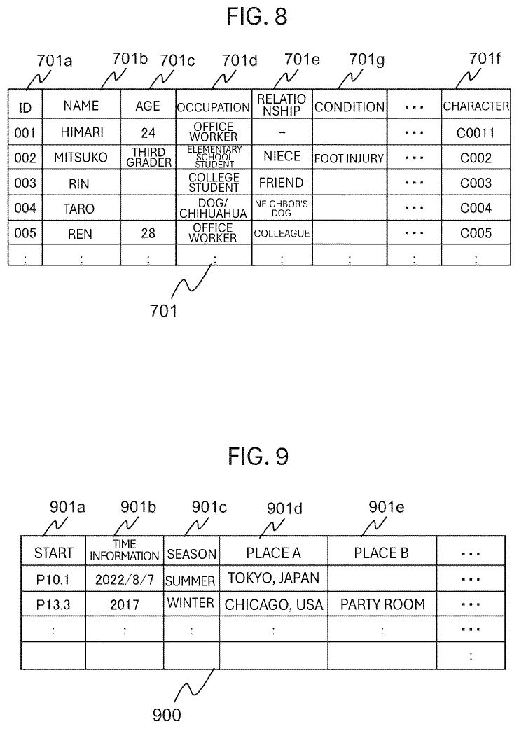

FIG. 9 illustrates an example of an environment information database to be recorded in the environment information storage section 193.

In an environment information database 900 illustrated in FIG. 9, for example, environment information is recorded when the appearing object extraction section 183 extracts a scene setting in the document as the environment information together with the appearing object in the content analysis performed in step S042. As a specific example of the environment information, a start 901a of the environment information database 900 is indicative of the position information on the book, which is, for example, the position where the scene changes. In the start 901a, not only start position information but also termination position information may be recorded. Time information 901b is indicative of the time information about the scene, season 901c is indicative of the season information, a place A 901d is indicative of, for example, a geographical location, and a place B 901 is indicative of, for example, information about a building or a room. In addition, more detailed environment information such as temperature and weather information may be recorded. The character image generation section 184, which will be described later, may refer to the environment information database 900 to generate a character of an age in accordance with the environment information, or change the clothes or the like of the character depending on the season and place.

### (S05: Reading Support Information Generation Processing)

In the first embodiment, a character image corresponding to an appearing object is generated as the reading support information. The character image is generated, for example, by reflecting the attribution information about the appearing object in a reference model and processing the shape thereof. The attribution information includes the information to be used for the shape processing on the character image, for example, appearance information about the appearing object, physical constitution information including the height and weight, and age information.

The attribution information further includes text information indicative of the name, age, and the like. These items of text information may be displayed together with the character image.

Furthermore, as will be described later, in the case of using a correlation chart as the reading support information, the attribution information is used in the generation thereof.

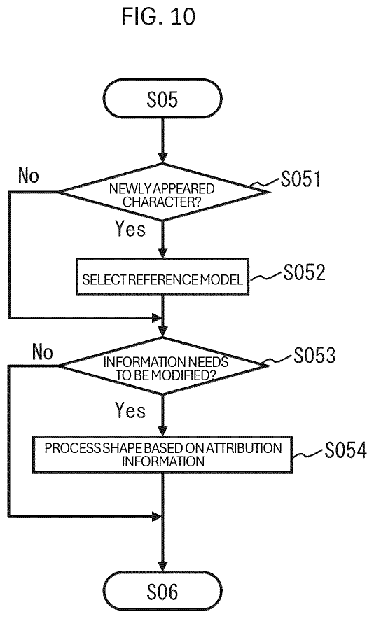

FIG. 10 illustrates a flowchart showing the details of the reading support information generation processing.

The character image generation section 184 determines whether there is a new character (S051). If there is a new character (S051: Yes), the character image generation section 184 selects one reference model serving as the basis for generating a character image of the new character (S052), and the processing proceeds to step S053.

The character image is generated, for example, by reflecting the attribution information about the appearing object in a reference model and processing the shape thereof. The attribution information includes the information to be used in the processing of the shape of the character image, such as the appearance information about the appearing object, the physical constitution information including the height and weight, and the age information.

Multiple types of reference models having different features of appearance, for example, gender, face, and physique are prepared for a plurality of characters. In the case of displaying an object other than a human, reference objects for animals are prepared. The reference models of animals may be prepared for each type of animal, and in particular, reference models of dogs, cats, and the like may be prepared for each breed. In the case where the same breed animals appear, the character image generation section 184 changes the shapes of the reference models thereof in accordance with the description information, if any, so that they can be distinguished from each other. On the other hand, in absence of specific feature description, the character image generation section 184 may change the patterns, color tones, and the like to highlight a difference among them.

In the case of a character that does not have any attribution information which allows the reference model to be selected, for example, a reference model of a human without a feature form may be used. The reference model may be replaced with another optimum reference model if it is determined that the change of a reference model is necessary which is caused by the additional attribution information.

In the case where there is no new character (S051: No) or after selection of the reference model (S052), the character image generation section 184 determines whether the appearing object information and the environment information are to be modified (S053). If modification is necessary (S053: Yes), the character image generation section 184 processes the shape based on the additional attribution information (S054). If there is no modification (S053: Yes) or after step S054, the processing proceeds to the character image display processing (step S06).

In the following, specific examples of the shape processing based on the attribution information will be described. The character image generation section 184 generates a character image by carrying out, for example, age edition and feature edition on the reference model.

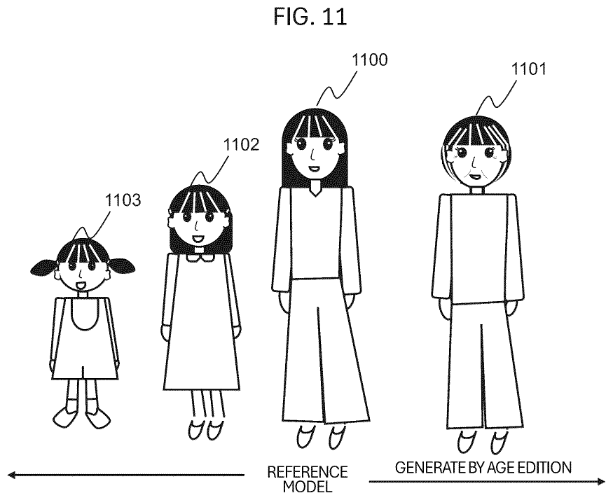

FIG. 11 is a schematic diagram illustrating an example of the age edition processing carried out on a reference model of a human.

For example, in the case of using a reference model 1100 which is assumed to be a 20 years old female, the character image generation section 184 carries out the age edition processing on the reference model 1100 so as to bring it close to the age obtained from the description information. For example, in the case of a character who is a woman of an advanced age, the character image generation section 184 processes the shape of the reference model 1100 to generate an elderly female model 1101. On the other hand, in the case of a character corresponding to the reference model 1100 who is young according to the description information, the character image generation section 184 carries out the age edition processing on the reference model 1100 and processes the shape of the reference model 1100 to generate a child model 1102, and if she is much younger, an infant model 1103.

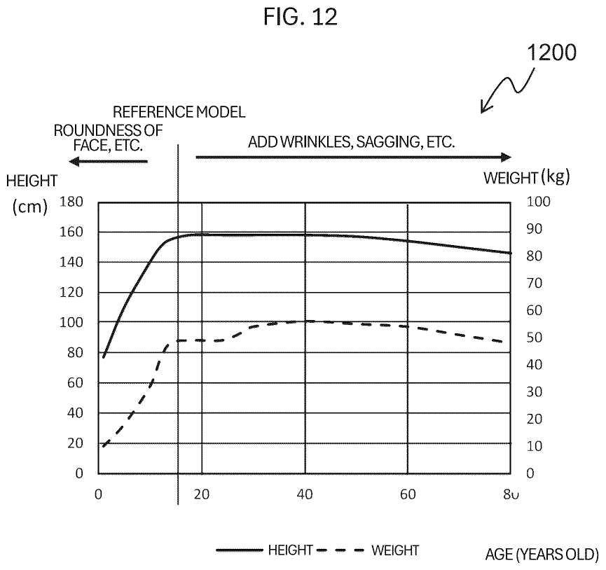

FIG. 12 is a diagram illustrating an example of the age edition using a physical constitution chart.

A physical constitution chart 1200 illustrated in FIG. 12 includes a height curve representing the age on the horizontal axis and the height on the vertical axis, and a weight curve representing the age on the horizontal axis and the height on the vertical axis. In this example, the age of the reference model is 18 years, and if a character to be processed is younger than the reference model, the roundness of the face is added to the reference model, and if older, the wrinkles and sagging are added thereto. The character image generation section 184 carries out the shape edition processing on the reference model 1100, referring to the age edition data using the physical constitution chart 1200.

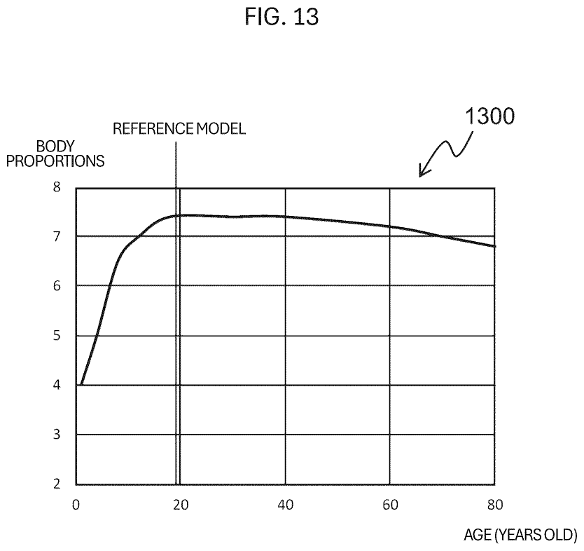

FIG. 13 is a diagram illustrating an example of the age edition processing using a body proportions chart.

A body proportions chart 1300 illustrated in FIG. 13 represents the age on the horizontal axis and the body proportions on the vertical axis. In this example, the reference model is 18 years old, and if a character to be processed is younger than the reference model, the value of the body proportions is made smaller while, if older, the value of the body proportions is made almost unchanged until 60 years old but made slightly smaller if more than 60 years old. In the same manner as the physical constitution chart 1200, it may be set to add wrinkles and sagging. The character image generation section 184 carries out the shape edition processing on the reference model 1100, referring to the age edition data using the body proportions chart 1300.

Although not illustrated, in the case where the description information for modifying the appearance of the character, for example, the hairstyle, body shape, presence or absence of eyeglasses, and the like is available in step S053, the character image generation section 184 modifies the appearance of the character.

The change in appearance due to age has been described above, however, after the growth period, the change in appearance due to age does not necessarily have to be strictly reproduced. For example, it may be reproduced every 5 years or every 10 years.

The description information may be not only the direct description information about the characters, but may be the environment information such as the seasons, passage of years and time, places, or the like. The character image generation section 184 may change the appearance of a character based on the environment information.

### (S06: Character Image Display Processing)

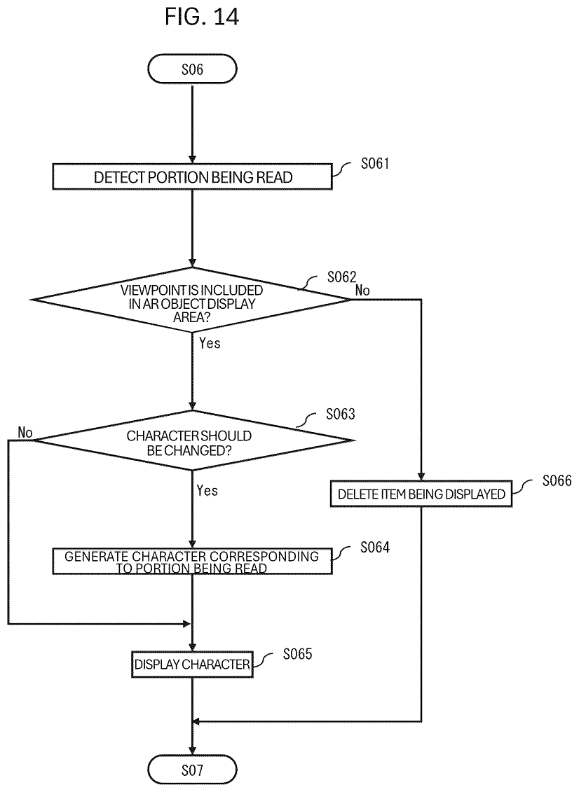

FIG. 14 illustrates a flowchart of a detailed processing example of the character image display processing.

The display control section 185 detects a portion that the user U1 is reading based on the line-of-sight information output from the line-of-sight detection sensor 156, which has been obtained by detecting the line-of-sight of the user U1 who is reading the book (S061).

Upon determining that the viewpoint is not included in an AR object display area (S062: No), the display control section 185 hides the character image or the like from the AR object display area (S066) if being displayed, and the processing proceeds to step S07.

Upon determining that the viewpoint is included in the AR object display area (S062: Yes), the display control section 185 carries out the processing for displaying a character image in the AR object display area.

These steps enable the control of displaying the character image when the user U1 is looking away from the book to look at the AR object display area while not displaying the character image when the user is not looking at the AR object display area.

The “AR object display area” is the area in which the reading support information including a character image and the attribution information about an appearing object corresponding to the character image are displayed. The AR object display area is set in a place that does not cover the area where the user U1 sees the book through the display. For example, the display control section 185 detects the position of the book in the real space where the book is present relative to the HMD G1, based on the information about the distance to the book detected by the distance measurement sensor 153. Strictly speaking, the document area corresponds to the area inside the outer edge of the book as the text and margins around the text are captured in the captured image of the book, however, for convenience of explanation, the book position refers herein to the position of the document area.

The display control section 185 sets the AR object display area at a predetermined position of the peripheral area which is the real space around the book position. Although a predetermined place can be defined in various manners, it is preferable that the amount of movement of the viewpoint from the book area becomes relatively small so as to allow the user to easily see the reading support information while reading the book. Considering the above, the AR object display area may be set in an area of the real space from the outer edge of the book position to, for example, the outer side of 10 cm.

As described above, by defining a predetermined place of the peripheral area based on the book area, in response to the movement of the book, the book area can be moved following the movement of the book at the predetermined place of the peripheral region. Thus, for example, even if the user U1 changes his or her posture while reading from the sitting posture to the recumbent posture and thus the book position changes, the AR object display area can be set at a predetermined position of the peripheral area of the book position.

In response to the determination by the display control section 185 that the viewpoint is included in the AR object display area (S062: Yes), the appearing object extraction section 183 determines whether the character image being displayed needs to be changed based on the description information about the portion being read (S063). If it is determined that the character image needs to be changed (S063: Yes), the character image generation section 184 generates a character image corresponding to the portion being read based on the appearing object information (S064). If it is determined that the character image does not need to be changed (S063: No), the processing proceeds to S065.

If the additional information about the appearing object is not line with the form of the current character image, the character image generation section 184 modifies the character image based on the additional information as needed. For example, in the case where the image obtained by processing the shape of the reference model based on the age so as to have a long hair had been used as the character image of Mitsuko but the description information that “Mitsuko looked good with her short hair” is obtained as the additional information, the character image generation section 184 modifies the image “C001” of the character field of the appearing object information database 701 illustrated in FIG. 7 to the image “C0011” of the short hair.

The display control section 185 displays, in the AR object display area, a character image generated for the portion that was read by the user U1 (S065). Then, the processing proceeds to step S07.

The determination of whether the character needs to be changed (S063) and the update of the character (S064) may be carried out before the determination of whether the viewpoint of the user U1 is included in the AR object display area (S062).

In the case where the number of appearing objects increases, the display control section 185 may enlarge the AR object display area that has been set.

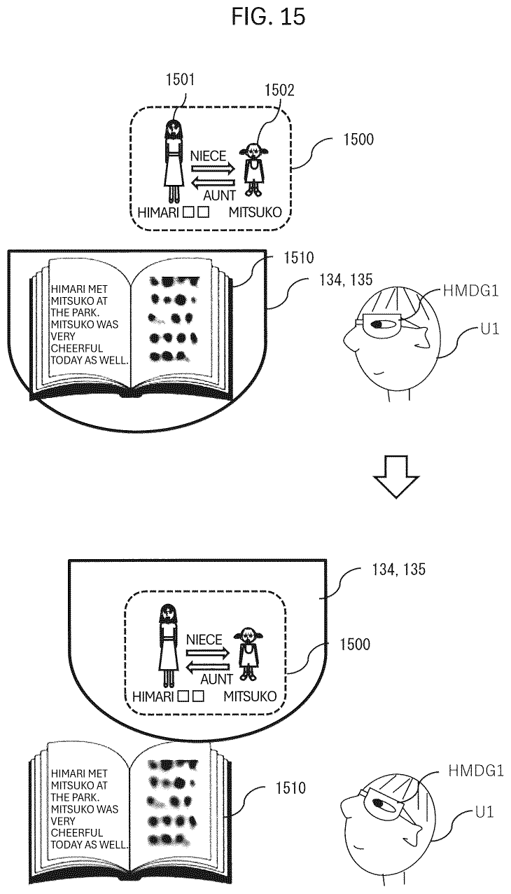

FIG. 15 is a schematic diagram illustrating a display example of a character image.

When the user U1 is reading a book 1510 in the manner as illustrated in the upper part of FIG. 15, the book 1510 is seen through the left display 134 and the right display 135. In this case, character images 1501, 1502 displayed in the AR object display area 1500 are not displayed on the left display 134 and the right display 135.

When the user U1 takes his or her eyes from the book 1510 and looks at a predetermined position of a peripheral area of the book 1510, in which the AR object display area 1500 is set, in the manner as illustrated in the lower part of FIG. 15, the character images 1501, 1502 are displayed on the left display 134 and the right display 135. At this time, the user U1 is looking at the peripheral area of the book position where the book 1510 is actually present.

As described above, by looking at a position of the real space in which the AR object display area 1500 is set or a display area of the left display 134 or the right display 135 corresponding to the position of the real space while reading, the user U1 can check the appearing object of the document written in the book.

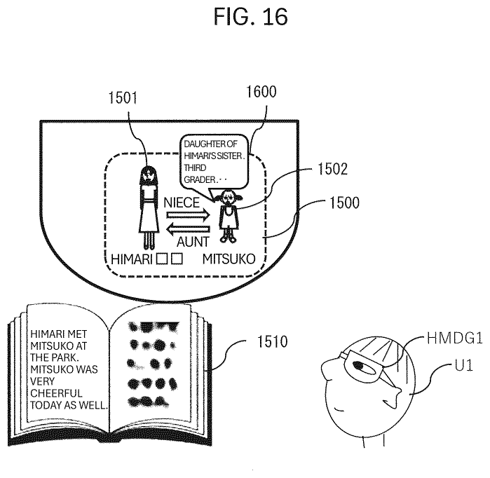

FIG. 16 is a schematic diagram illustrating a display example of a character image, particularly, a detailed display example.

As illustrated in FIG. 16, it may be configured that, when the user U1 selects the character image being displayed in the AR object display area 1500, detailed information 1600 about the appearing object corresponding to the character image as selected is displayed. The operation of selecting a character image may be performed using a gesture, manipulation of a button (not illustrated), audio input, or line-of-sight input, which is not particularly limited.

By displaying the detailed information 1600 only when the selection operation is performed, it is possible to preferentially display the information desired by the user U1 in the case where the area of the AR object display area 1500 is limited.

In the above description, the case of a printed book has been described as an example, however, the medium on which the document is written may be a smartphone screen or a monitor screen of a personal computer.

According to the present embodiment, the user support during reading is performed for, not only an electronic book, but also any document written in various forms of books desired to be read by the user U1 by capturing an image thereof by a camera mounted on a portable information terminal. This enables reading support, not only in the case of such as e-books, but also even in the case of not provided with electronic data of a book in advance.

Furthermore, in the present embodiment, the portable information terminal autonomously generates the book information about the document being read by the user U1, extracts and stores the information about the appearing object, and displays the reading support information using the character image generated for each appearing object by the AR display technique. Thus, even when the user wants to check the previously described information such as the age and occupation of the appearing object while reading the document, he or she can view the reading support information displayed in AR without turning over the page and reading the document again.

Still further, in the present embodiment, the character image is generated by changing the reference model so as to correspond to the attribution information about the appearing object extracted by the portable information terminal, so that the user support in which the character image matching the content of the document is displayed in AR display can be realized. This enables the user U1 to intuitively grasp the attribution of the appearing object.

Still further, the AR display of the reading support information is carried out only for a portion being read by the user U1. This prevents, for example, the information that the user U1 has not read yet from being displayed before the user U1 reads the document including the information, and thus prevents a problem of, for example, so-called spoilers which reduce the enjoyment of reading for the user U1.

In the case where the portable information terminal determines that the book has been already read, for example, when the user U1 read the portion that had been read again or read the same book repeatedly, the appearing object information may be generated and displayed in AR using the attribution information about the appearing object corresponding to the portion after the portion being currently read.

### Second Embodiment

In the first embodiment, the reading support information is displayed using the AR display technique when the line of sight of the user U1 is included within the AR object display area. On the other hand, in the second embodiment, the reading support information is displayed using the AR display technique when unsureness is found in the user U1.

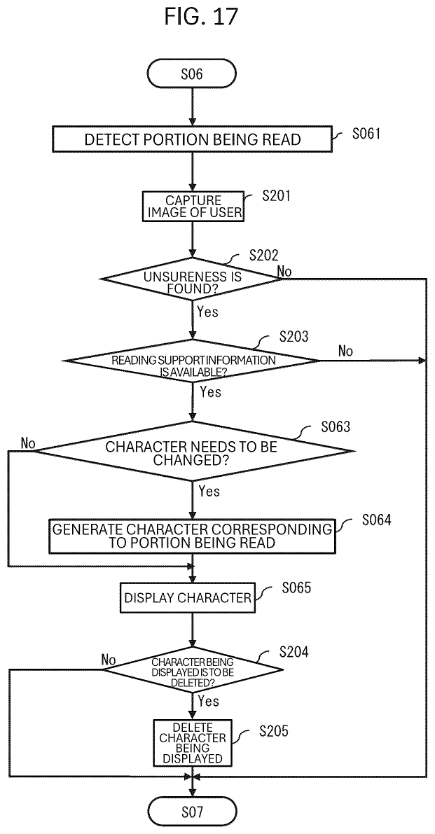

FIG. 17 illustrates a flowchart of a flow of processing according to the second embodiment.

The display control section 185 detects a portion that the user U1 is reading based on the line-of-sight position information about the user U1 detected by the line-of-sight detection sensor 156 (S061).

Next, in the case of using a user image in the processing for detecting unsureness of the user U1, an image of the user is captured (S201). In the case of not using the user image in the unsureness detection processing, this step is skipped.

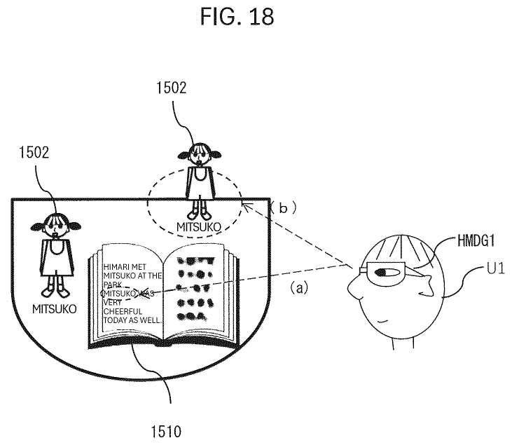

The unsureness detection processing has various types depending on what is used as a material for determination about whether the unsureness is found, such as a line of sight, a facial expression, a motion of a finger, and the like. FIG. 18 is a diagram illustrating an example of unsureness detection processing.

FIG. 18 illustrates examples of: (a) determination based on whether the line of sight is staying or moving back, and (b) determination based on whether the line of sight is moving to the upper left.

In the case of (a) determination based on whether the line of sight is staying or moving back, for example, it may be determined that the user wants to know the information about “Mitsuko” when his or her line of sight moves back to “Mitsuko” after staying in “Mitsuko” for a certain period of time or after reading the document (or the paragraph).

In the case of (b) determination based on whether the line of sight is moving to the upper left, the information about the appearing object which appears within a predetermined range from the portion that has been read (determined based on the line of sight) may be displayed in AR. This is because the line of sight generally goes to the upper left (line of sight moves from (a) to (b) in FIG. 18) when the person considers.

In a further example of the unsureness detection processing, a designated operation for expressing that the user U1 is unsure, such as audio input or a gesture operation, may be detected.

The unsureness detection processing described above may be executed solely by the HMD G1 or by another information apparatus communicated with the HMD G1, for example, a smartphone. In the case of solely using the HMD G1, the operation of detecting the line of sight of the user U1 using the line-of-sight detection sensor 156 mounted on the HMD G1 corresponds to step S201 of capturing an image of the user. In the case of using a smartphone as another information apparatus, an operation of capturing a facial image of the user U1 with a camera mounted on the smartphone or capturing an image of a gesture operation performed by the user U1 corresponds to step S201 of capturing an image of the user. In the case where the unsureness detection processing is executed by a smartphone, the unsureness detection is carried out using a result of detection of the line of sight based on the facial image.

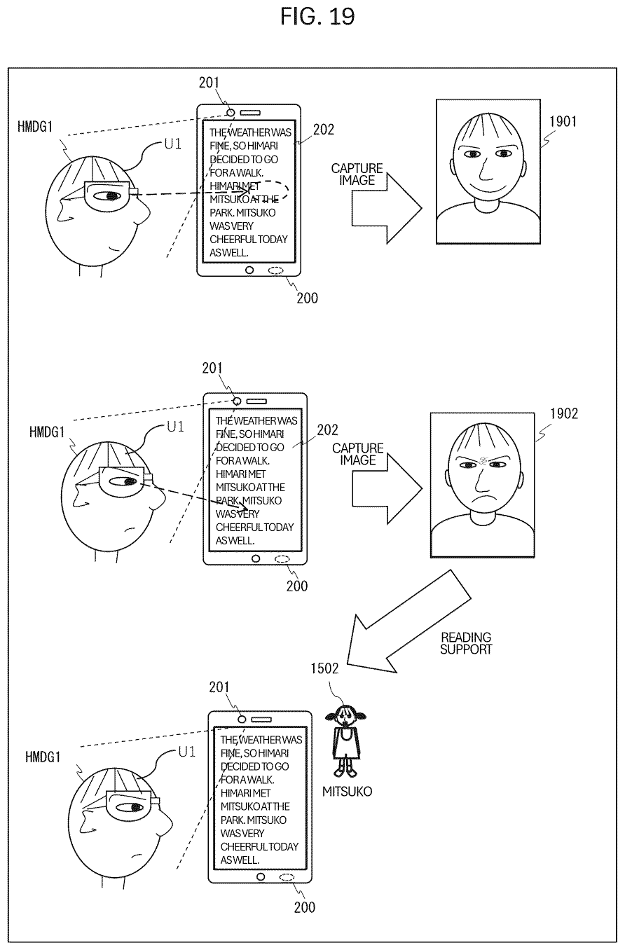

FIG. 19 is a diagram illustrating a further example of the unsureness detection processing.

In FIG. 19, the HMD G1 and the smartphone 200 are communicated with each other, and the smartphone 200 captures a facial image of the user U1. Then, the unsureness detection processing is carried out based on the facial expression of the user U1 obtained from the facial image.

In the following, the example in which the user U1 is reading the text information being displayed on a screen 202 of the smartphone 200 will be described. The face of the user U1 who is reading is captured by an in-camera 201 of the smartphone 200 to obtain a facial image 1901 of the user U1. The smartphone 200 transmits the facial image 1901 to the HMD G1 so that the display control section 185 can execute facial expression identification processing. If the facial expression of the user U1 is normal, it is determined that the unsureness has not been found in the user U1.

On the other hand, as a result of the facial expression identification processing carried out by the display control section 185 based on the facial image 1902 captured by the smartphone 200, if it is identified that the facial expression of the user U1 corresponds to the troubled expression with wrinkled brows, it is determined that the unsureness has been found. The facial expression identification processing is carried out by extracting the facial feature information such as, not only wrinkled brows, but also narrowed eyes, wandering gaze, and the like. Furthermore, the facial expressions of the user U1 during reading may be accumulated and used for determination. For example, among the facial images of the user U1, machine-learning may be carried out for the facial images obtained when the unsureness was determined to be found as the teacher data so that the unsureness detection processing can be carried out using the facial images obtained when the unsureness was detected in the user U1 as the input data.

In the case where the display control section 185 determines that the unsureness has been found (S202: Yes) and the reading support information to be displayed is included in the portion being read by the user U1 detected in step S061 (S203: Yes), whether the character image should be changed is determined (S063). In the case where it needs to be changed (S063: Yes), the character corresponding to the portion being read by the user U1 is generated (S064) and displayed (S065). In the case where the character being displayed is to be deleted thereafter (S204: Yes), it is deleted (S205) and then the processing proceeds to step S07. In the case where the character being displayed is not to be deleted (S204: No), the processing proceeds to step S07 as well.

In the case where it is determined that the unsureness has not been found (S202: No) or is determined that no reading support information is included (S203: No), the processing proceeds to step S07.

According to the present embodiment, unsureness of the user U1 is detected and the reading support information is displayed in AR. The reading support information is necessary when the user U1 is unsure while AR display thereof is not necessity when the user U1 is not unsure because he or she does not need to refer to it. According to the present embodiment, the AR display of the reading support information is carried out only when it is needed by the user U1, which enables the reading support so as not to hinder the concentration of the user U1 during reading. Furthermore, energy saving effects can be expected by not carrying out unnecessary AR display.

The object information which has been described above may be displayed and output, through the speaker 142, together with the audio data as synthesized therewith. Outputting the object information as audio allows the user U1 to obtain the necessary information without moving the line of sight from the position where he or she is reading. For example, the synthesized audio data may be generated by using the same acoustic model, such as a narrator, or by selecting an acoustic model suitable for each character.

Furthermore, the speaker 142 may be set such that a left-ear speaker and a right-ear speaker are arranged at positions of left and right temples of the HMD G1, respectively, and the synthesized audio data may be generated for the left-ear speaker and the right-ear speaker so that it can be heard from the display area using a three-dimensional sound technique or the like. By using such three-dimensional sound, in addition to the effect of hearing sounds from the display direction, it is possible to inform the user U1 of the direction of the display area by allowing the user U1 to hear the synthesized audio data when the display area is not included within his or her field of view. The output of synthesized sound is not limited to this embodiment but can be applied to other embodiments.

### Third Embodiment

The third embodiment is the embodiment for autonomously generating a correlation chart of appearing objects and displaying it as the reading support information. Autonomous generation of the correlation chart of the appearing objects may be executed in parallel with the execution of the character image generation processing in step S05 so that the correlation chart can be displayed together with the character image or popped up as the detailed information as needed in the character image display processing in step 06. Instead of executing the character image display processing, autonomous generation of the correlation chart of the appearing objects may be executed so that the correlation chart can be displayed in AR as the reading support information. In the following, an example of execution in parallel with display of the character image will be described.

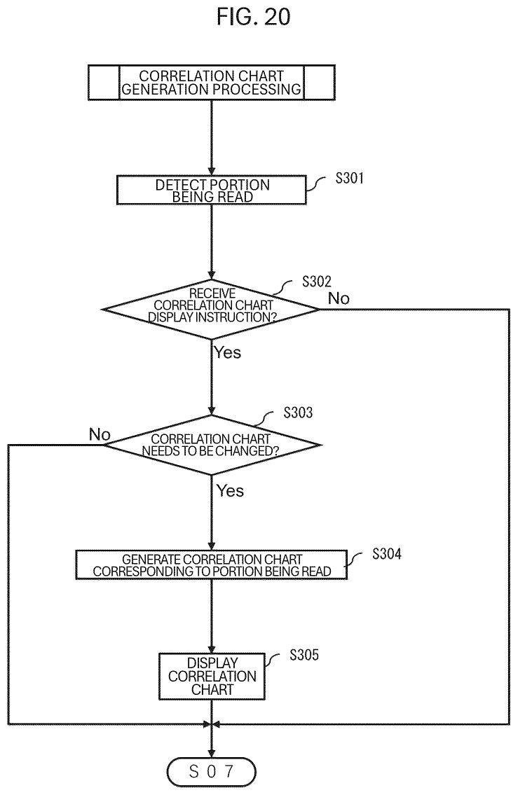

FIG. 20 illustrates a flowchart of a flow of processing according to the third embodiment. The correlation chart generation processing illustrated in FIG. 20 corresponds to an aspect of the reading support information generation processing.

In the same manner as step S061, the display control section 185 detects a portion being read by the user U1 based on the position information about the line of sight of the user U1 detected by the line-of-sight detection sensor 156 (S301).

In the same manner as step S062, the display control section 185 checks whether there is a correlation chart display instruction (S302). If there is no correlation chart display instruction (S302: No), the processing proceeds to step S07.

In the case where there is a correlation chart display instruction (S302: Yes) and the appearing object extraction section 183 determines that the correlation chart including the character image being displayed needs to be changed based on the description information about the portion being read (S303: Yes), the correlation chart generation section 186 generates a correlation chart corresponding to the portion being read (S304).

In the case where the appearing object extraction section 183 determines that the correlation chart does not need to be changed (S303: No), the displaying control section 185 displays the current correlation chart. In the case where the correlation chart was generated in step S304, the displaying control section 185 displays the newly generated correlation chart (S305). Then, the processing proceeds to step S07.

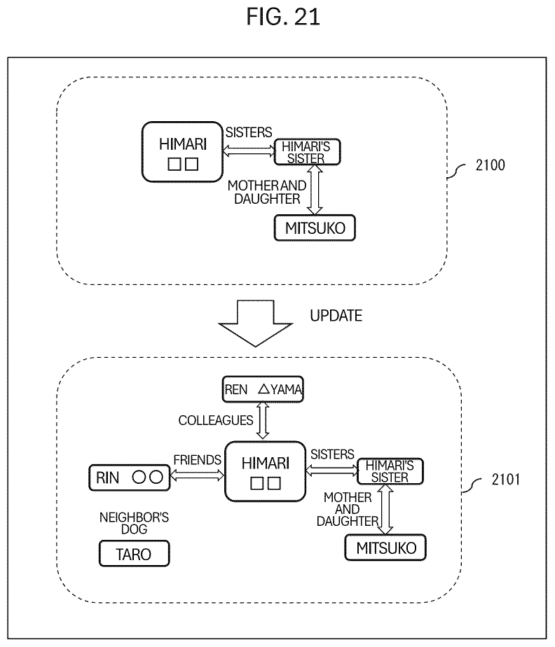

FIG. 21 is a schematic diagram illustrating an example of autonomous generation of a correlation chart of appearing objects according to the third embodiment.

The correlation chart generation section 186 generates the correlation chart based on the appearing object information. Furthermore, the correlation chart generation section 186 generates a correlation chart corresponding to the portions that have been read by the user U1. For example, suppose that a correlation chart 2100 has been already created, and when the appearing object information is updated based on the description information about the portion that the user U1 is reading which was detected in step S301, the correlation chart generation section 186 adds the correlation based on the content included in the description information to the correlation chart 2100 to generate a correlation chart 2101.

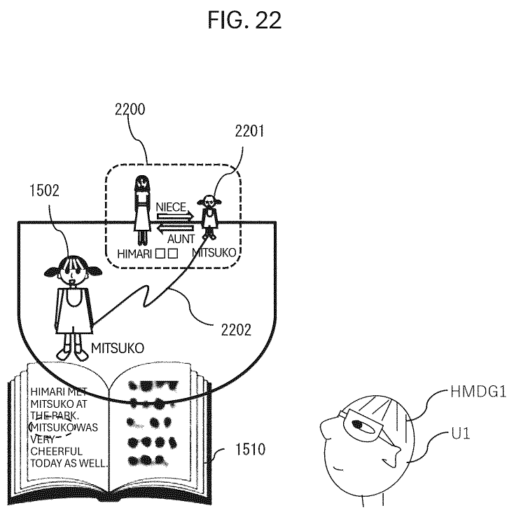

FIG. 22 is a schematic diagram illustrating a display example of a correlation chart according to the third embodiment.

Upon determining that “Mitsuko” appears in the portion where the user U1 is reading, the display control section 185 enlarges and displays a character image 1502 as Mitsuko near the book. Then, the display control section 185 sets a correlation chart display area 2200 and displays a correlation chart including an appearing object corresponding to the character image 1502. At this time, a line 2202 for associating the enlarged character image 1502 and the image 2201 of the same character to be displayed in the correlation diagram with each other may be drawn as an AR object. This makes it easier for the user U1 to see the position of the appearing object corresponding to the portion that the user U1 is reading within the correlation diagram even in the case of the correlation diagram including a plurality of appearing objects.

Furthermore, in the case where a plurality of character images is being displayed, a correlation chart based on the character image selected by the user U1 may be displayed.

The appearing objects included in the correlation chart are not limited to that for the persons described on the page that is being read by the user U1, and may be that for the ones written on the immediately preceding page or a plurality of persons in the same scene may be written in the correlation chart.

In FIG. 22, the correlation chart display area 2200 is set to display the correlation chart, however, the correlation may be displayed as the detailed information. For example, the text information indicative of “daughter of sister” at the beginning of the detailed information 1600 illustrated in FIG. 16 corresponds to the information indicative of the correlation.

According to the present embodiment, not only the attribution information about the appearing object but also the correlation among the appearing objects can be displayed as the reading support information, which enables the reading support for the user who is reading such a document having a large number of appearing objects to be effectively performed.

### Forth Embodiment

The fourth embodiment is the embodiment for generating a plot summary up to the portion of the book where a user stopped reading and displaying the plot summary thus generated as an AR object when the user starts reading the book again. The processing of generating and displaying a plot summary may be executed as the alternative processing of the character image generation and display processing (S05, S06) illustrated in FIG. 6, or may be executed in parallel to execution of them.

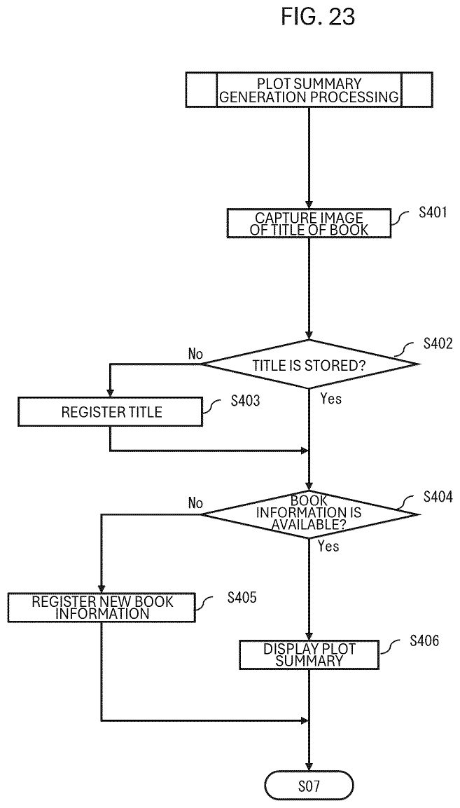

FIG. 23 illustrates a flowchart of a flow of processing according to the fourth embodiment.

The plot summary generation section 187 acquires a title image obtained by capturing the title of the book (S401), and carries out the title recognition processing (S402). The title image may be the image obtained by capturing the front cover or the back cover of the book, or in the case where the title is written in the header or the footer of the page being read by the user U1, the image obtained by capturing the page being read by the user U1 may be used as the title image.

The plot summary generation section 187 refers to the book information storage section 191 to determine whether the title recognized in step S402 is stored in the book information storage section 191. In the case where it is not stored (S402: No), the plot summary generation section 187 newly registers the title in the book data storage section 191 (S403).

In the case where the title recognized by step S402 is stored in the book information storage section 191 (S402: Yes) or after newly registering the title (S403), the plot summary generation section 187 determines whether the book information for this title is stored in the book information storage section 191 (S404).

In the case where no book information for this title is not stored in the book information storage section 191 (S404: No), the plot summary generation section 187 newly registers the book information (S405), and then the processing proceeds to step S07.

In the case where the book information for this title is stored in the book information storage section 191 (S404: Yes), the plot summary generation section 187 generates and displays a plot summary based on the book information (S406), and then the processing proceeds to step S07.

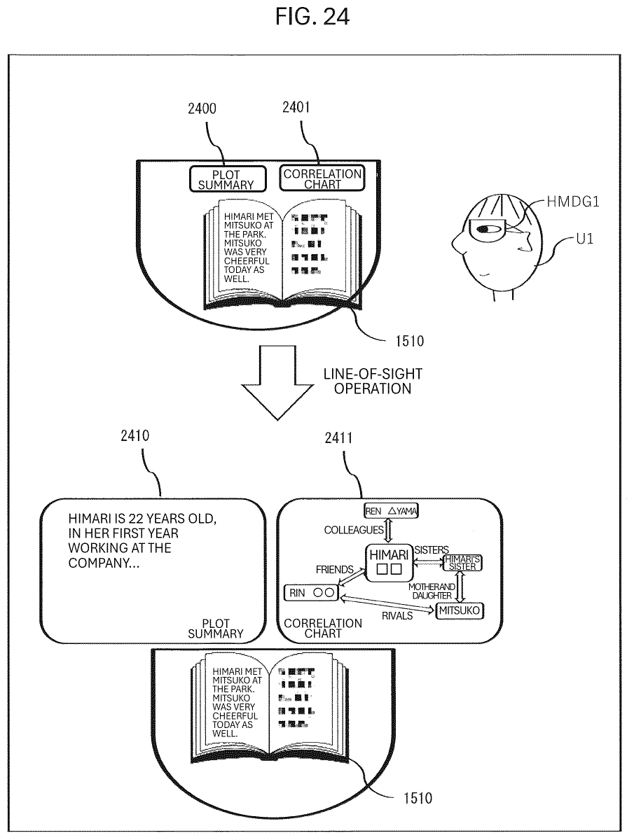

FIG. 24 is a diagram illustrating a display example of a plot summary.

The display control section 185 displays a plot summary icon 2400 in AR, which is provided for requesting display of a plot summary, in the peripheral area of the book 1510. A correlation chart icon 2401 for requesting display of a correlation chart may also be displayed in AR.

When the line-of-sight detection sensor 156 detects that the user U1 has aligned their gaze with the plot summary icon 2400, that is, when a so-called line-of-sight operation is detected, the display control section 185 may set a plot summary display area 2410 in the peripheral area and make it popped-up. In the same manner, in response to the selection of the correlation chart icon 2401 performed by the line-of-sight operation, the display control section 185 may set a correlation chart display area 2411 in the peripheral area to make it popped-up.

According to the present embodiment, it is possible to perform the reading support for the user U1 in the case where reading is restarted from the middle, by displaying a plot summary preceding the restarted portion as the reading support information.

### Fifth Embodiment

The fifth embodiment is the embodiment relating to how to obtain a character model.

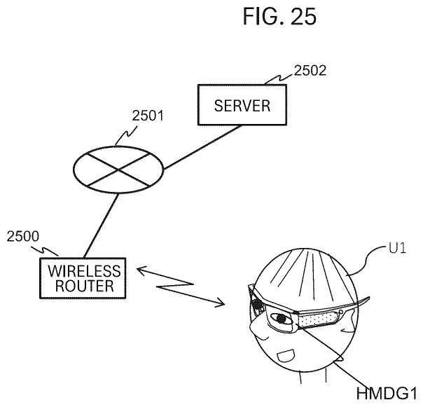

FIG. 25 is a schematic diagram illustrating an example of obtaining a character model from an external apparatus.

The HMD G1 communicates with a server 2502 via a wireless router 2500 and a network 2501. Then, the HMD G1 selects and downloads the character model stored in the server 2502. The downloaded character model may be used as a reference model.

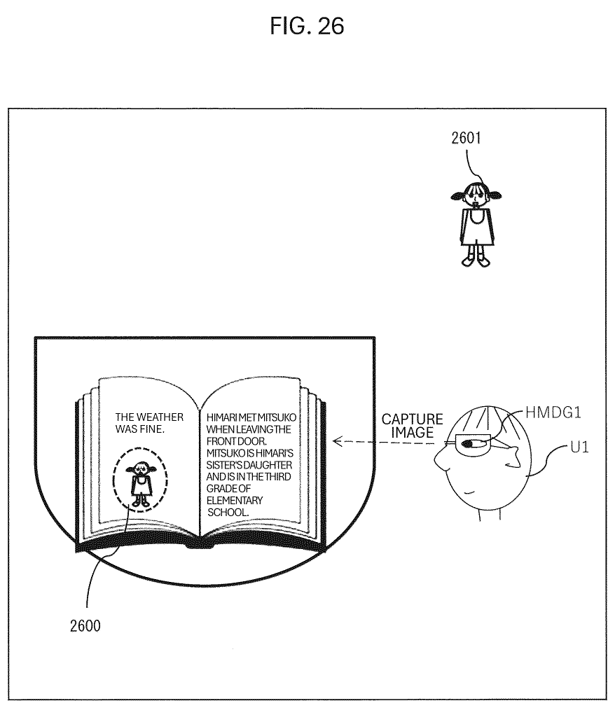

FIG. 26 is a schematic diagram illustrating an example of cutting a character model out from an illustration.

The character image generation section 184 recognizes an illustration of a person or the like from an image of a book to determine an appearing object appearing on the page where the illustration is included or a page adjacent thereto based on the document and the description information included nearby. Then, the character image generation section 184 associates the determined appearing object with the illustration, and registers, as the reference model of the appearing object, a person image, an animal image, or the like drawn as the illustration in the appearing object information DB.

In the example illustrated in FIG. 26, upon recognizing a person image based on an illustration 2600 and determining that an appearing object with the name of “Mitsuko” will appear based on the description information about the page next to the page including the illustration, the character image generation section 184 uses the person image of the illustration as a reference model 2601 of “Mitsuko”. At this time, associating the shape of the reference model 2601 and the age at that time therewith based on the description information allows the character image with the features closer to those according to the description information to be generated by the age edition.

According to the present embodiment, widening the selection range of a reference model enables the reading support in which the preference of the user U1 is reflected more, and thus the reading support adjusted to the feeling that the user U1 experiences while reading.

### Sixth Embodiment

The sixth embodiment is the embodiment for carrying out support in viewing a video rather than reading a book.

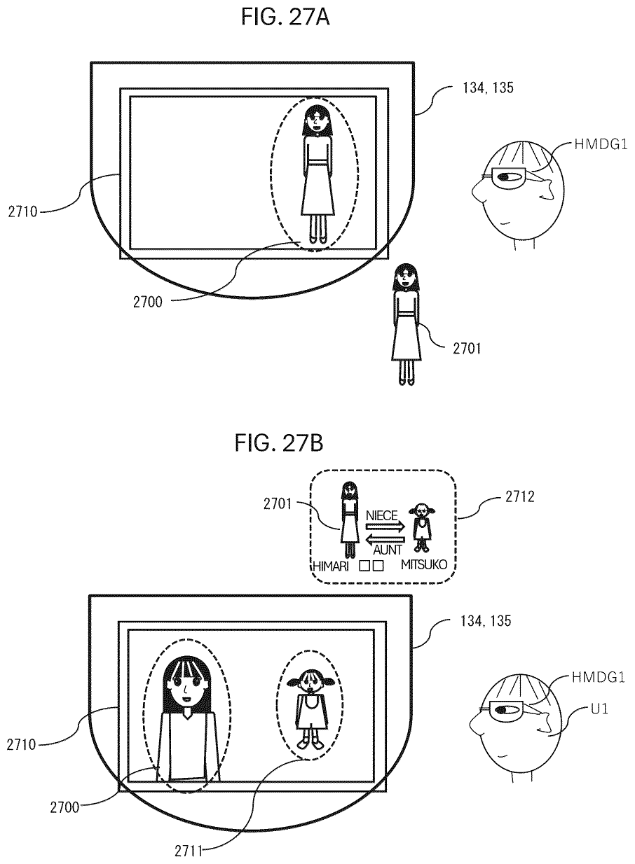

In the present embodiment, the character image generation section 184 may generate the appearing object information based on a video or an audio of a certain content. Each of FIG. 27A and FIG. 27B is a schematic diagram illustrating an example of cutting a character model out from a video.

FIG. 27A illustrates the example in which the user U1 is watching a screen in which a character 2700 is on the video being displayed on a display 2710 through the HMD G1. The HMD G1 captures the video being displayed using the front camera 131, recognizes a person from the captured image by the face detection or the like, and extracts the person. In FIG. 27A, the character 2700 is recognized and extracted from the video. At this time, as illustrated in FIG. 27B, the upper body image may be cut out, or as illustrated in FIG. 27A, the whole body image may be cut out. A character model 2701 is generated based on the character 2700 extracted from the video, and is registered in the appearing object information DB. For generating the character model 2701, an image obtained by cutting out a person from a video of a certain scene may be used, or a three-dimensional character model may be generated using a plurality of videos, by complementing a video, or the like.

Then, the audio recognition processing may be executed based on the audio information output together with the video to generate the appearing object information based on the result of the audio recognition processing. Then, the character 2700 cut out from the video is made associated with the character model 2701 and registered in the appearing object information DB. In generating the appearing object information, the content information transmitted together with the content may be used. If the content information is available in the server, the appearing object information may be generated using the content information acquired via the network.

According to the examples in FIG. 27A and FIG. 27B, a character model and a reference model can be obtained based on a video. In a further application, the HMD G1 is worn to watch a video, and a reference model is generated based on the video information and the appearing object information is generated based on the audio information. This may allow, in the same manner as a video, the character description (for example, a correlation chart 2712 with another character 2711 relating to the character 2700) and a plot summary to be generated and displayed in AR. According to the present embodiment, viewing support for watching a video such as a movie involving many characters, which is likely to have a story with a complicated correlation among the characters, is provided. Furthermore, in the case of support for watching a movie, a user can see the explanation about the characters in AR without temporarily stopping watching the story and rewinding. Therefore, even when multiple users are watching the same video simultaneously, it is possible to realize the video viewing support according to each user's level of understanding.

### Seventh Embodiment

The seventh embodiment is the embodiment for, in the case where a map as an illustration or a drawing for reference is included in a book, displaying it in AR as the reading support information. The present embodiment may be executed in addition to the user support processing using a character image, or may be executed in parallel thereto.

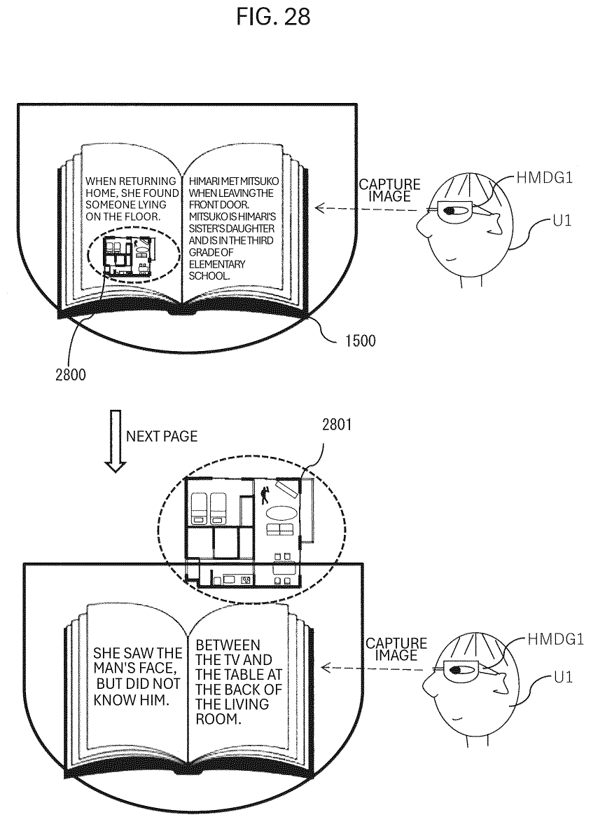

FIG. 28 is a schematic diagram illustrating an example of displaying an illustration or a diagram for reference in AR.

The appearing object extraction section 183 recognizes and cuts out an illustration from the book image. Then, the appearing object extraction section 183 makes determination about the content of the illustration based on the document near the illustration, and stores the image of the illustration and the content thereof in the environment information storage section 193. The character image generation section 184 generates a character image in which the illustration is reflected, and displays the illustration in AR based on the description information about the document until the scene changes.

In FIG. 28, the HMD G1 captures an image of the book 1510 and cuts out an illustration 2800. The appearing object extraction section 183 displays the illustration 2800 in AR in the scene where the illustration 2800 is included based on the description information. At this time, the line-of-sight detection sensor 156 detects the portion being read by the user U1 based on the viewpoint of the user U1 so as not to reflect the information included in a portion ahead of the portion as detected in an AR object image 2801.

In the example illustrated in FIG. 28, the illustration 2800 includes an image of a floor layout of a house. In the illustration 2800, a person lying down is not included.

When the user U1 finishes reading the sentence of “when returning home, she found someone lying on the floor”, the character image generation section 184 generates and displays the AR object image 2801 obtained by adding the person lying down to an AR object image 2802 of the floor layout.

The AR object image 2801 is made hidden when the scene changes to another place from the house, for example, a scene in a foreign country.

According to the present embodiment, in the case where an illustration for a certain scene is included, the reading support can be realized by displaying the illustration in AR when a user reads the page for the same scene which does not include the illustration. In the case where the story progresses in the same scene, making the content of the progress reflected in an AR object image of the illustration allows a user to understand the story easier.

### Eighth Embodiment

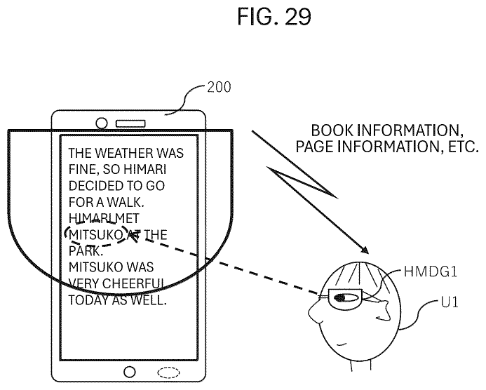

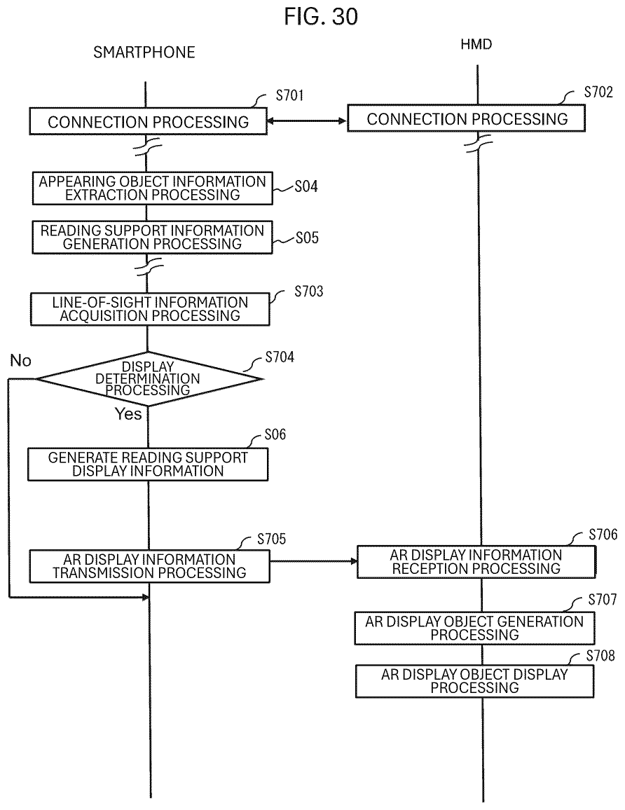

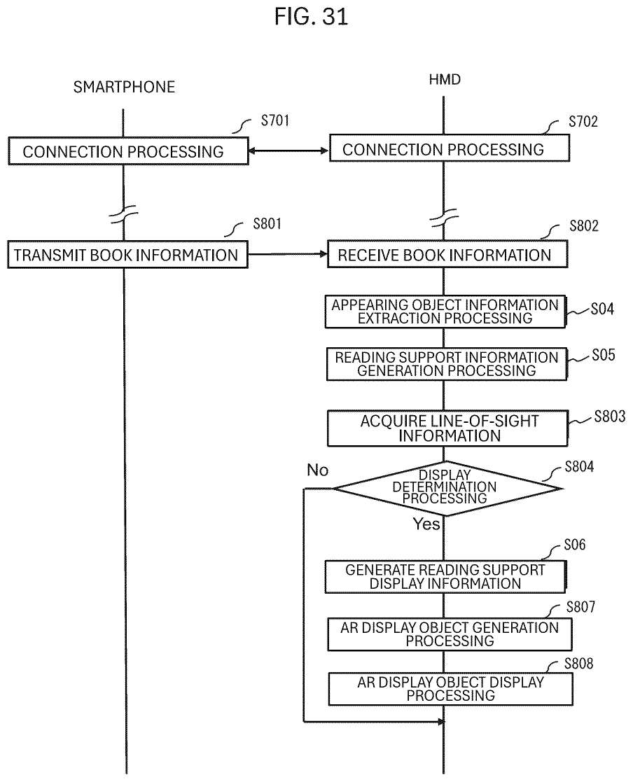

The eighth embodiment is the embodiment for carrying out the reading support or video viewing support by linking a plurality of items of mobile information. FIG. 29 is a diagram illustrating a virtual reality display system according to the eighth embodiment. FIG. 30 illustrates a flowchart of a flow of processing according to the eighth embodiment. FIG. 31 illustrates a flowchart of a flow of processing (processing example 2) according to the eighth embodiment.

The virtual reality display system illustrated in FIG. 29 is configured with the HMD G1 and another information terminal, such as a smartphone 200, which are communicated with each other.

### Processing Example 1

FIG. 30 illustrates a processing example 1. First, the smartphone 200 and the HMD G1 carry out the connection processing S701 and the connection processing S702, respectively. In the connection processing S701 and the connection processing S702, the smartphone 200 and the HMD G1 acquire the authentication information such as the identifiers thereof using the short-range wireless communication I/F or the like, so that they can be connected with each other.

The smartphone 200 carries out the appearing object information extraction processing S04 based on the book data about the electronic book to create an appearing object database and an environment information database.

In the line-of-sight information acquisition processing S703, the line-of-sight information is acquired to acquire the position information about the portion being read by the user U1 together with the page information about the book being displayed by the smartphone.

In the display determination processing S704, whether AR display is necessary is determined. The determination that AR display is necessary is made (YES), for example, in response to the determination that an AR display setting has been set or that the support display is necessary based on the staying of the line of sight, facial expressions, or the like. In the case where the AR display is necessary (YES), the reading support display information processing S06 is carried out to generate the information relating to a character image or the AR display information for displaying an AR object such as a correlation chart, as needed. In the AR display information transmission processing S705, the generated display information is transmitted to the HMD G1.

The HMD G1 receives the AR display information in the AR display information transmission processing S706. In the AR display object generation processing S707, an AR display object to be displayed is generated using the AR display information. In the AR display object display processing S708, the generated AR display object is displayed on the display. The HMD G1 detects the position of the smartphone based on the information about the captured image by the front camera, and displays the AR display object in such a manner to prevent it from overlapping the smartphone.

### Processing Example 2

The HMD G1 acquires the book information, the page information, and the like from the smartphone 200. Then, the HMD G1 acquires a line of sight, generates a character image, and displays it in AR.

FIG. 31 illustrates a processing example 2. First, the smartphone 200 and the HMD G1 carry out the connection processing S701 and the connection processing S702, respectively. In the connection processing S701 and the connection processing S702, the smartphone 200 and the HMD G1 acquire the authentication information such as the identifiers thereof using the short-range wireless communication I/F or the like, so that they can be connected with each other.

In the book information transmission processing S801, the smartphone 200 transmits the book data about the electronic book to the HMD G1. In the book information transmission processing S802, the HMD G1 receives the book data, carries out the appearing object information extraction processing S04, and creates an appearing object database and an environment information database.

In the line-of-sight information acquisition processing S803, the line-of-sight information is acquired, and the position information about the portion being read by the user U1 is acquired together with the page information about the book being displayed by the smartphone.

In the display determination processing S804, whether AR display is necessary is determined. The determination that AR display is necessary is made (YES), for example, in response to the determination that an AR display setting has been set or that the support display is necessary based on the staying of the line of sight, facial expressions, or the like. In the case where the AR display is necessary (YES), the reading support display information processing S06 is carried out to generate the information relating to a character image or the AR display information for displaying an AR object such as a correlation chart, as needed.

In the AR display object generation processing S807, an AR display object to be displayed is generated using the AR display information. In the AR display object display processing S808, the generated AR display object is displayed on the display. The HMD G1 detects the position of the smartphone based on the captured image by the front camera and displays the AR display object in such a manner to prevent it from overlapping the smartphone.

When the user U1 turns the page of the electronic book of the smartphone 200, the smartphone 200 may provide the HMD G1 with a notification that the page has been turned together with the page information.

According to the present embodiment, it is possible to reduce the workload of the HMD G1 as compared with the case of generating and displaying an AR object image such as a character image solely by the HMD G1. This enables suppression of heat generation in the HMD G1, and thus improvement in usability of the HMD G1.

According to each embodiment described above, displaying clear characters corresponding to appearing objects as the reading support information using the AR display technique allows such an advantageous effect to be expected that a user can easily remember the appearing objects.

Furthermore, generating a character image by processing the shape of a reference model allows the character image of the same base to be used with the progress of the story, from which such an advantageous effect can be expected that a user can easily remember it.

The present invention is not limited to the embodiments described above, and various modifications can be made for the present invention. The embodiments described above have been explained in detail for the purpose of making it to understand the present invention easily, and thus are not necessarily limited to those having all the configurations as described. A part of the configuration of an embodiment may be replaced with the configuration of a further embodiment.

Furthermore, the configuration of other embodiments may be added to the configuration of a further embodiment. Still further, it is possible to add, delete, or replace some of the configuration of each embodiment with other configurations.

Still further, some or all the configurations described above may be implemented in hardware, for example, by designing them with integrated circuitry, a general-purpose processor, or a specific-purpose processor. A processor includes transistors, circuitry, and others, and is considered as circuitry or processing circuitry. Each of the features described above may be implemented in software by having the processor interpret and execute a program for implementing each function. The control lines and information lines which are considered to be necessary for the purpose of explanation are indicated herein, but not all the control lines and information lines of actual products are necessarily indicated. It may be considered that almost all the components are actually connected to each other.

As described above, the present embodiment includes the following inventions.

### (Appendix 1)

A portable information terminal, comprising:
a camera that captures an image of a field of view of a user and generates a captured image;
a display;
a memory;
a line-of-sight detection sensor that detects a line of sight of the user and outputs line-of-sight information; and
a processor,
the processor being configured to:
carry out an image analysis on the captured image to extract appearing object information including attribution information about an appearing object which appears in a document included in the captured image;
store the appearing object information in the memory;
acquire the line-of-sight information to identify a portion on which a viewpoint of the user is present;
generate a virtual reality object including a description about the appearing object corresponding to the portion on which the viewpoint of the user is present based on the appearing object information; and
display the virtual reality object in a display area of the display, which corresponds to a periphery of the document.

### (Appendix 2)

A portable information terminal, comprising:
a camera that captures an image of a field of view of a user and generates a captured image;
a display;
a memory; and
a processor,
the processor being configured to:
carry out an image analysis on the captured image to extract appearing object information including attribution information about an appearing object which appears in a video included in the captured image;
store the appearing object information in the memory;
identify a scene in which the video is being displayed based on the captured image;
generate a virtual reality object including a description about the appearing object corresponding to the scene in which the video is being displayed based on the appearing object information; and
display the virtual reality object in a display area of the display, which corresponds to a periphery of the video.

### (Appendix 3)

A method for displaying a virtual reality object, comprising the steps of:
by a processor,
carrying out an image analysis on a captured image in which a field of view of a user is captured, and based on description information included in a document captured in the captured image, extracting appearing object information including attribution information about an appearing object which appears in the document;
acquiring line-of-sight information to identify a portion on which a viewpoint of the user is present, the line-of-sight information being obtained and output by a line-of-sight detection sensor that has detected a line of sight of the user;
generating a virtual reality object including a description about the appearing object corresponding to the portion on which the viewpoint of the user is present based on the appearing object information; and
displaying the virtual reality object in a display area of a display, which corresponds to a periphery of the document.

### (Appendix 4)

A method for displaying a virtual reality object, comprising the steps of:
by a processor,
carrying out an image analysis on a captured image in which a field of view of a user is captured to extract appearing object information including attribution information about an appearing object which appears in a video included in the captured image;
identifying a scene in which the video is being displayed based on the captured image;
generating a virtual reality object including a description about the appearing object corresponding to the scene in which the video is being displayed based on the appearing object information; and
displaying the virtual reality object in a display area of a display, which corresponds to a periphery of the video.

### REFERENCE SIGNS LIST

G1: HMD
G10: housing
U1: user
101: main processor
102: system bus
110: storage apparatus
111: RAM
113: flash memory
120: input I/F
121: button switch
130: image processing apparatus
131: front camera
132: left camera
133: right camera
134: left display
135: right display
140: audio processing apparatus
141: microphone
142: speaker
143: audio decoder
150: sensor group
151: sensor
152: geomagnetic sensor
153: ranging sensor
154: acceleration sensor
155: gyroscope sensor
156: line-of-sight detection sensor
160: communication I/F
161: wireless communication I/F
162: telephone network communication I/F
163: short-range wireless communication I/F
171: lamp
172: extension I/F
173: timer
181: book information recognition section
182: book information generation section
183: appearing object extraction section
184: character image generation section
185: display control section
186: correlation chart generation section
187: generation section
191: book information storage section
192: appearing object information storage section
193: environment information storage section
194: reference model storage section
195: captured data acquisition section
196: line-of-sight information acquisition section
200: smartphone
201: in-camera
202: screen
301: control section
400: book
700: appearing object information database
701: appearing object information database
701a: “ID” field
701b: “name” field
701c: “age” field
701d: “occupation” field
701e: “relationship” field
701g: “condition” field
900: environment information database
901a: start
901b: time information
901c: season
1100: reference model
1101: female model
1102: model
1103: model
1200: physical constitution chart
1300: body proportions chart
1500: AR object display area
1501: character image
1502: character image
1510: book
1600: detailed information
1901: facial image
1902: facial image
2100: correlation chart
2101: correlation chart
2200: correlation chart display area
2201: image
2202: line
2400: icon
2401: correlation chart icon
2410: display area
2411: correlation chart display area
2500: wireless router
2501: network
2502: server
2600: illustration
2601: reference model
2700: character
2701: character model
2710: display
2711: character
2712: correlation chart
2800: illustration
2801: AR object image
2802: AR object image
A2700: person
A901d: place

1. A portable information terminal, comprising:
a camera that captures an image of a field of view of a user and generates a captured image;
a display;
a memory;
a line-of-sight detection sensor that detects a line of sight of the user and outputs line-of-sight information; and
a processor,
the processor being configured to:
carry out an image analysis on the captured image to extract appearing object information including attribution information about an appearing object which appears in a document included in the captured image;
store the appearing object information in the memory;
acquire the line-of-sight information to identify a portion on which a viewpoint of the user is present;
generate a virtual reality object including a description about the appearing object corresponding to the portion on which the viewpoint of the user is present based on the appearing object information; and
display the virtual reality object in a display area of the display, which corresponds to a periphery of the document.

2. The portable information terminal according to claim 1, wherein
in a case where the captured image includes a content that comes after a portion where the viewpoint of the user is present, the processor does not reflect the appearing object information extracted from the content in display of the virtual reality object.

3. The portable information terminal according to claim 1, wherein
the virtual reality object is a character image corresponding to the appearing object.

4. The portable information terminal according to claim 3, wherein
the processor is configured to:
store a reference model serving as a basis of the character image in advance; and
process a shape of the reference model by reflecting the appearing object information corresponding to the portion on which the viewpoint of the user is present to generate the character image.

5. The portable information terminal according to claim 4, wherein
the appearing object information includes age information about the appearing object, and
the processor processes the shape of the reference model based on the age information to generate the character image.

6. The portable information terminal according to claim 4, wherein
the appearing object information includes physical constitution information about the appearing object, and
the processor processes the shape of the reference model based on the physical constitution information to generate the character image.

7. The portable information terminal according to claim 1, wherein
based on the line-of-sight information, the processor displays the virtual reality object upon determining that the user is watching the display area of the display, which corresponds to the periphery of the document, and hides the virtual reality object being displayed upon determining that the user is not watching the display area of the display, which corresponds to the periphery of the document.

8. The portable information terminal according to claim 1, wherein
the virtual reality object is a correlation chart showing a correlation among a plurality of appearing objects.

9. The portable information terminal according to claim 1, wherein
upon determining, based on the line-of-sight information, that the user is unsure in understanding the appearing object, the processor displays the virtual reality object.

10. The portable information terminal according to claim 1, further comprising a communication unit for communicating with the information apparatus, wherein
when the communication unit receives reading support information from the information apparatus, the processor displays the virtual reality object.

11. The portable information terminal according to claim 1, wherein
the processor is configured to:
store book information indicative of a content of the document in the memory;
upon recognizing a title of a book based on the captured image, determine which portion the user is reading based on the line-of-sight information;
generate a plot summary of portions that have been read by the user based on the stored book information; and
generate the virtual reality object indicative of the plot summary.

12. A portable information terminal, comprising:
a camera that captures an image of a field of view of a user and generates a captured image;
a display;
a memory; and
a processor,
the processor being configured to:
carry out an image analysis on the captured image to extract appearing object information including attribution information about an appearing object which appears in a video included in the captured image;
store the appearing object information in the memory;
identify a scene in which the video is being displayed based on the captured image;
generate a virtual reality object including a description about the appearing object corresponding to the scene in which the video is being displayed based on the appearing object information; and
display the virtual reality object in a display area of the display, which corresponds to a periphery of the video.

13. A method for displaying a virtual reality object, comprising the steps of:
by a processor,
carrying out an image analysis on a captured image in which a field of view of a user is captured, and based on description information included in a document captured in the captured image, extracting appearing object information including attribution information about an appearing object which appears in the document;
acquiring line-of-sight information to identify a portion on which a viewpoint of the user is present, the line-of-sight information being obtained and output by a line-of-sight detection sensor that has detected a line of sight of the user;
generating a virtual reality object including a description about the appearing object corresponding to the portion on which the viewpoint of the user is present based on the appearing object information; and
displaying the virtual reality object in a display area of a display, which corresponds to a periphery of the document.

14. A method for displaying a virtual reality object, comprising the steps of:
by a processor,
carrying out an image analysis on a captured image in which a field of view of a user is captured to extract appearing object information including attribution information about an appearing object which appears in a video included in the captured image;
identifying a scene in which the video is being displayed based on the captured image;
generating a virtual reality object including a description about the appearing object corresponding to the scene in which the video is being displayed based on the appearing object information; and
displaying the virtual reality object in a display area of a display, which corresponds to a periphery of the video.
